(19) United States
(12) Patent Application Publication
(10) Pub. No.: US 2026/0074983 A1
(43) Pub. Date: Mar. 12, 2026

(54) FIRST NETWORK NODE, SECOND NETWORK NODE, AND METHODS PERFORMED THEREBY FOR HANDLING A SET OF NODES PROVIDING A SEGMENTED FRONT-HAUL

(71) Applicant: Telefonaktiebolaget LM Ericsson (publ), Stockholm (SE)

(72) Inventors: Jale SADREDDINI, Sariyer/Istanbul (TR); Andres REIAL, Höllviken (SE); Omer HALILOGLU, Sariyer/Istanbul (TR)

(21) Appl. No.: 19/104,823

(22) PCT Filed: Aug. 31, 2022
(86) PCT No.: PCT/TR2022/050925

§ 371 Date: Feb. 19, 2025

(51) Int. Cl. H04L 45/12; H04L 45/121

(52) U.S. Cl. CPC H04L 45/127; H04L 45/121

(57) ABSTRACT

A method performed by a first network node operating in a communications network comprising the set of nodes providing a segmented front-haul. The first network node determines, out of a respective first subset of nodes to serve a respective device of one or more devices, a respective second subset of nodes to serve each respective device. The determining is based on information obtained from a second network node. The information comprises respective routing information between a respective source node of respective one or more packets, and the respective device, so that a respective delivery of the respective packets to the respective device is based on an improvement of one or more metrics. The first network node also initiates sending of the respective one or more packets to the respective device via the determined respective second subset of nodes.

The project leading to this application has received funding from the European Union's Horizon 2020 research and innovation program under grant agreement No 101013425.

### TECHNICAL FIELD

The present disclosure relates generally to a first network node, and methods performed thereby, for handling a set of nodes providing a segmented front-haul. The present disclosure also relates generally to a second network node and methods performed thereby for handling the set of nodes providing the segmented front-haul.

### BACKGROUND

Wireless devices within a wireless communications network may be e.g., User Equipments (UE), stations (STAs), mobile terminals, wireless terminals, terminals, and/or Mobile Stations (MS). Wireless devices may be enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc . . . , based on transmission power and thereby also cell size. A cell may be understood as the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

### NR

The standardization organization 3rd Generation Partnership Project (3GPP) is currently in the process of specifying a New Radio Interface called New Radio (NR) or 5G-Universal Terrestrial Radio Access (UTRA), as well as a Fifth Generation (5G) Packet Core Network, which may be referred to as Next Generation (NG) Core Network, abbreviated as NG-CN, NGC or 5G CN.

In the current concept, gNB denotes an NR BS, where one NR BS may correspond to one or more transmission and/or reception points.

One of the main goals of NR is to provide more capacity for operators to serve ever increasing traffic demands and variety of applications. Because of this, NR may be able to operate on high frequencies, such as frequencies over 6 GHz, until 60 or even 100 GHz.

Operation in higher frequencies makes it possible to use smaller antenna elements, which enables antenna arrays with many antenna elements. Such antenna arrays facilitate beamforming, where multiple antenna elements may be used to form narrow beams and thereby compensate for the challenging propagation properties.

### Internet of Things (IoT)

The Internet of Things (IoT) may be understood as an internetworking of communication devices, e.g., physical devices, vehicles, which may also be referred to as “connected devices” and “smart devices”, buildings and other items—embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that may be understood to be a self and/or automatically controlled unattended machine and that may be understood to be typically not associated with an active human user in order to generate data traffic. An MTC device may be typically simpler, and typically associated with a more specific application or purpose, than, and in contrast to, a conventional mobile phone or smart phone. MTC may be understood to involve communication in a wireless communication network to and/or from MTC devices, which communication typically may be of quite different nature and with other requirements than communication associated with e.g. conventional mobile phones and smart phones. In the context of and growth of the IoT, it is evident that MTC traffic will be increasing and thus needs to be increasingly supported in wireless communication systems.

### D-MIMO

Distributed Multiple-Input and Multiple-Output (D-MIMO), also known as “cell-free massive MIMO”, Radio Stripes, RadioWeaves, etc. may be understood as a key technology candidate for the Sixth Generation (6G) physical layer. Cell-free may be understood to mean that, in contrast to using one of several access points (APs) to form a cell with a fixed configuration, the cell-free concept may be understood to allow grouping multiple APs in a flexible manner based on where the UEs may be located. While there may be no prior fixed “cell” definition for data transmission, for control and broadcast information distribution, there may still be more traditional cells.

The basic idea of D-MIMO may be understood to be to distribute service antennas geographically and have them operate phase-coherently together. A typical architecture may be that multiple antenna panels, also known as access points (APs) may be interconnected and configured in such a way that more than one panel may cooperate in coherent decoding of data from a given UE, and more than one panel may cooperate in coherent transmission of data to a UE. Each panel in turn may comprise multiple antenna elements that may be configured to operate phase-coherently together. The preferred way of operation may be in time-division duplexing (TDD), relying on reciprocity of the propagation channel, whereby uplink pilots transmitted by the UEs may be used to obtain both the uplink and downlink channel responses simultaneously. This type of TDD operation may be usually called reciprocity-based operation. Various research projects, for example H2020-REINDEER, are addressing aspects relating to this architecture, including the design of beamforming methods, random access signaling and procedures, etcetera.

### Modular D-MIMO: Radio Stripes and Radio Weaves

To make deployment of a large number of distributed Multiple-Input and Multiple-Output (MIMO) access points simple and cost efficient, various approaches have been proposed, such as Radio Stripes and RadioWeaves. A common feature may be understood to be to use a shared fronthaul (FH) together with a high degree of integration and miniaturization, see FIG. 1 and FIG. 2. Sometimes, the electronic circuit containing the digital signal processing (DSP), antenna panel, and external interfaces, for power supply and data, may be denoted by antenna processing unit (APU). In this document, it may be referred to as Access Point (AP). Note however that APs may not be visible physical boxes, they may in some cases be only the location of a small integrated circuit inside of a protective cable.

FIG. 1 depicts a schematic example illustration of an antenna processing unit 1 top view in panel a) and side view in panel b), respectively. The antenna processing unit 1 may comprise one or more antenna elements 2, which may be located in an antenna panel 3, and an external interface 4 on a printed circuit board (PCB) 5. In panel b), the external interface 4 is depicted as a separate component. The DSP 6 is depicted under the antenna panel 3.

FIG. 2 is a schematic diagram representing two different network deployment and architecture examples. Panel a) depicts a non-limiting example of the RadioWeaves planar approach to interconnect APs. Panel b) depicts a non-limiting example of the RadioStripes linear approach to interconnect APs. It may be appreciated that a Central Processing Unit (CPU) 21 may be connected, via one or more connections, to a plurality of APs 22. A CPU may be understood as a node, e.g., Distributed Unit (DU), with coordinating capabilities for connection control among APs in a centralized manner. In case of ad-hoc structure, a CPU may not have any controller role. Each of the APs 22 may connected to another AP 22 via one or more FH segments 23. The plurality of APs 22 may be arranged in a dispersed, planar, form in the radioweave, or in a linear form in the radio stripe.

### Segmented Fronthaul

The fronthaul structure used by e.g., RadioStripes and RadioWeaves may be referred to as segmented fronthaul. Each AP may be connected to one or more neighboring APs via interfacing segments that may be used for transferring power, DL data packets and precoding weights, UL combining weights and symbol estimates, etc. The existence of the plurality of segments between the APs may be understood to then result in a segmented fronthaul. An important property of such FH structure may be understood to be that a given AP may be generally not directly connected to the CPU but may signal to and from it may need to pass multiple segments to reach their destinations. To transfer signals to and from multiple UEs and multiple APs, careful routing solutions may be required to utilize the data transfer capabilities of the segments as fully as possible. The segment capacities in terms of data packets per time unit may be estimated e.g., in Gigabits per second (Gbps) or in UE packets/radio slot. Herein, routing may be understood to denote the necessary data, user-plane and/or control-plane data, forwarding throughout fronthaul network, and not addressing any Internet Protocol (IP)-level routing.

In spite of the benefits of D-MIMO, current segmented FH approaches under certain circumstances may result in loss of diversity gain.

### SUMMARY

As part of the development of embodiments herein, one or more challenges with the existing technology will first be identified and discussed.

In current segmented FH approaches, AP grouping for each co-scheduled UE may be first performed to define the serving AP subset that may transmit data to the UE, using joint coherent precoding. The grouping may be based on radio considerations, e.g., UE-AP pair link qualities, maximum number of UEs that an AP may simultaneously serve, etc. and per-group combining weights may be determined. Subsequently, or in parallel, a routing solution may be determined to distribute DL data from CPU to the APs, and/or forward UL data from APs to the CPU. If a routing path for AP cannot be established due to FH segment capacity limitations, the resulting DL precoding may be highly suboptimal since a missing Tx component will distort the spatial energy focusing and interference null steering, or resulting UL combining, e.g., may lose diversity gain.

To obtain an optimal solution for resource utilization, joint grouping and routing approaches that explicitly test different grouping options and check their resulting routing solutions to determine the best grouping options may be envisioned. An approach may then be selected that may maximize a chosen metric, e.g., maximum number of APs connected, best composite Signal to Interference and Noise Ratio (SINR) metric over UEs, etc. which may then be considered the optimal solution with respect to that metric. However, this approach may be feasible only for a very low number of UEs and APs; its complexity for scenarios of practical interest is prohibitive.

As another alternative, individual UEs may be accommodated sequentially, selecting the preferred AP group for each UE and determining whether it may be routed, and subsequently only keeping UEs whose APs may be successfully routed. However, this may be understood to be highly inefficient in terms of fronthaul resource utilization and may result in blocking many UEs.

There is a thus need for a low-complexity approach to jointly consider AP grouping and routing requirements that may avoid blocking UEs unnecessarily and may provide robust precoding in the presence of routing failures for some APs.

According to the foregoing, it is an object of embodiments herein to improve the handling of a set of nodes providing a segmented front-haul in a communications network.

According to a first aspect of embodiments herein, the object is achieved by a method, performed by a first network node. The method is for handling a set of nodes providing a segmented front-haul. The first network node operates in the communications network comprising the set of nodes. The first network node determines, out of a respective first subset of nodes in the set of nodes to serve a respective device of one or more devices, a respective second subset of nodes. The respective second subset of nodes is determined to serve each respective device of the one or more devices. The determining is based on information obtained from a second network node operating in the communications network. The information comprises respective routing information between a respective source node of respective one or more packets for the respective device of the one or more devices and the respective device. The respective second subset of nodes is determined, so that a respective delivery of the respective one or more packets to the respective device of the one or more devices is based on an improvement of one or more metrics. The first network node then initiates sending of the respective one or more packets to the respective device of the one or more devices via the determined respective second subset of nodes.

According to a second aspect of embodiments herein, the object is achieved by a method, performed by a second network node. The method is for handling the set of nodes providing the segmented front-haul. The second network node operates in the communications network comprising the set of nodes. The second network node receives a first indication from the first network node operating in the communications network. The first indication indicates the determined respective first subset of nodes in the set of nodes to serve the respective device of the one or more devices. The second network node then determines, responsive to receiving the first indication, for the respective first subset of nodes, the information. The information comprises the respective routing information between the respective source node of the respective one or more packets for the respective device of the one or more devices and the respective device. The information is based on the determined respective first subset of nodes. The information enables the first network node to determine, out of the respective first subset of nodes, the respective second subset of nodes to serve each respective device of the one or more devices, so that the respective delivery of the respective one or more packets to the respective device of the one or more devices is based on the improvement of one or more metrics. The second network node then also sends a second indication to the first network node. The second indication indicates the determined information.

According to a third aspect of embodiments herein, the object is achieved by the first network node, for handling the set of nodes configured to provide the segmented front-haul. The first network node is configured to operate in the communications network configured to comprise the set of nodes. The first network node is configured to determine, out of the respective first subset of nodes in the set of nodes to serve the respective device of the one or more devices, the respective second subset of nodes to serve each respective device of the one or more devices. The determining is configured to be based on the information configured to be obtained from a second network node configured to operate in the communications network. The information is configured to comprise the respective routing information between the respective source node of the respective one or more packets for the respective device of the one or more devices and the respective device. The respective second subset of nodes is configured to be determined, so that the respective delivery of the respective one or more packets to the respective device of the one or more devices is configured to be based on the improvement of one or more metrics. The first network node is further configured to initiate sending of the respective one or more packets to the respective device of the one or more devices via the respective second subset of nodes configured to be determined.

According to a fourth aspect of embodiments herein, the object is achieved by the second network node, for handling the set of nodes configured to provide the segmented front-haul. The second network node is configured to operate in the communications network configured to comprise the set of nodes. The second network node is further configured to receive the first indication from the first network node configured to operate in the communications network. The first indication is configured to indicate the determined respective first subset of nodes in the set of nodes to serve the respective device of one or more devices. The second network node is also configured to determine, responsive to receiving the first indication, for the respective first subset of nodes, the information configured to comprise the respective routing information between the respective source node of the respective one or more packets for the respective device of the one or more devices and the respective device. The information is configured to enable the first network node to determine, out of the respective first subset of nodes, the respective second subset of nodes to serve each respective device of the one or more devices, so that the respective delivery of the respective one or more packets to the respective device of the one or more devices is configured to be based on the improvement of the one or more metrics. The second network node is additionally configured to send the second indication to the first network node. The second indication is configured to indicate the information configured to be determined. The information is configured to be based on the respective first subset of nodes configured to be determined.

By determining the respective second subset of nodes based on the routing information obtained from the second network node so that the respective delivery of the respective one or more packets is based on the improvement of one or more metrics, the first network node may provide an approach for performing practical device-centric grouping of nodes, e.g., AP grouping for data routing in the communications network, e.g., a distributed MIMO network with segmented fronthaul. The first network node may be enabled to perform the grouping in way that out of all the nodes that may be available to serve a particular device for delivery of packets, a customization of the group of nodes may be performed for the routing of the one or more packets, on a device to device basis, so that the one or more metrics of choice may be improved. By the information concerning routing being obtained from the second network node, the approach followed by the first network node to perform the grouping of nodes may have a complexity that may barely exceed the complexity of disjoint grouping and routing operations but may perform close to the optimal joint solution.

By initiating sending of the respective one or more packets to the respective device via the determined respective second subset of nodes, the first network node may enable to deliver the respective one or more packets to the respective device while improving the one or more metrics for the respective device and/or for one or more of the other one or more devices.

By determining the information comprising the routing information, the second network node may be enabled to find packet routing paths from the respective source node, e.g., CPU, to the destination node, that is, the serving node(s), to serve each device, possibly in a predetermined priority order, and report success and/or failures regarding which serving nodes may have been connected for each device. By sending the information to the first network node, the second network node may enable the first network node to then use this information to perform the dynamic adjustment of the determined respective first subsets of nodes, in a way that may result in the improvement of the one or more metrics.

Embodiments herein may enable to simplify system design and reduce cost and overall complexity by allowing to keep the radio grouping and routing methods, separate. Coordination and alignment may be ensured via cooperation and information exchange without the need for a joint grouping/routing algorithm, which may be understood to otherwise result in a system of high cost and complexity.

### BRIEF DESCRIPTION OF THE DRAWINGS

Examples of embodiments herein are described in more detail with reference to the accompanying drawings, and according to the following description.

FIG. 1 depicts a schematic example illustration of an antenna processing unit, top view in panel a) and side view in panel b).

FIG. 2 is a schematic diagram representing two different network deployment and architecture examples, RadioWeaves in panel a) and RadioStripes in panel b).

FIG. 3 is a schematic diagram illustrating a communications network, according to embodiments herein.

FIG. 4 is a flowchart depicting an example of a method performed by a first network node, according to embodiments herein.

FIG. 5 is a flowchart depicting an example of a method performed by a second network node, according to embodiments herein.

FIG. 6 is a schematic representation depicting aspects of a non-limiting example of a method according to embodiments herein.

FIG. 7 is a schematic representation depicting aspects of a non-limiting example of a method according to embodiments herein.

FIG. 8 is a schematic representation depicting aspects of a non-limiting example of a method according to embodiments herein.

FIG. 9 is a schematic representation depicting aspects of a non-limiting example of a method according to embodiments herein.

FIG. 10 is a schematic representation depicting aspects of a non-limiting example of a method according to embodiments herein.

FIG. 11 is a schematic representation depicting aspects of a non-limiting example of a method according to embodiments herein.

FIG. 12 is a schematic representation depicting aspects of a non-limiting example of a method according to embodiments herein.

FIG. 13 is a schematic representation depicting aspects of a non-limiting example of a method according to embodiments herein.

FIG. 14 is a schematic representation depicting aspects of a non-limiting example of a method according to embodiments herein.

FIG. 15 is a schematic block diagram illustrating two non-limiting examples, a) and b), of a first network node, according to embodiments herein.

FIG. 16 is a schematic block diagram illustrating two non-limiting examples, a) and b), of a second network node, according to embodiments herein.

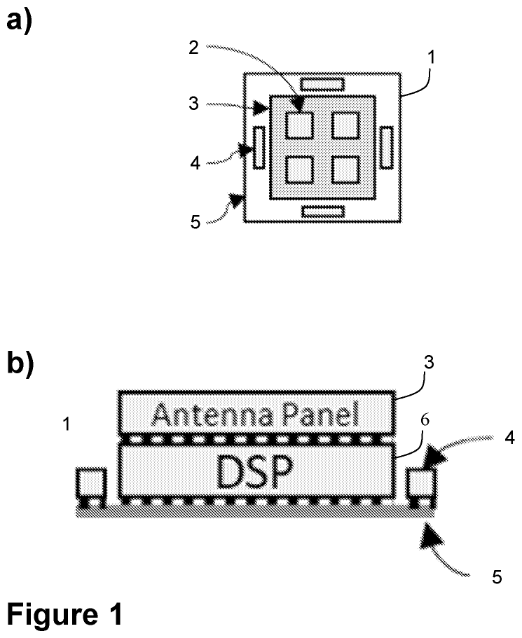

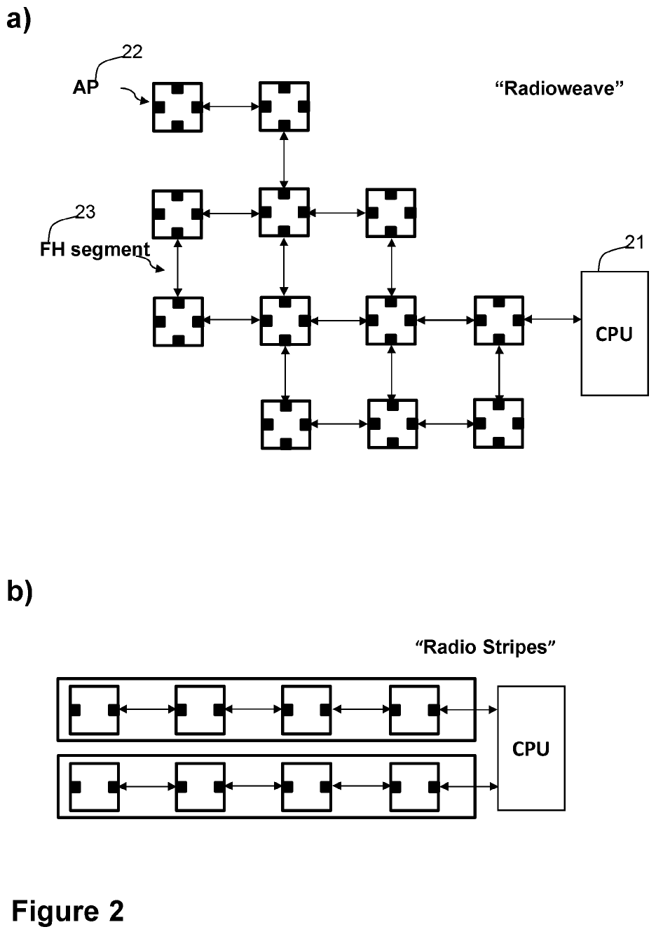

### DETAILED DESCRIPTION

Certain aspects of the present disclosure and their embodiments may provide solutions to the challenge discussed in the Summary section or other challenges. There are, proposed herein, various embodiments which address one or more of the issues disclosed herein.

As a general overview, embodiments herein relate to AP grouping with resource-constrained routing. Particularly, embodiments herein may provide a low-complexity joint AP grouping and data routing approach for precoded DL transmissions in a D-MIMO deployment with segmented FH.

According to embodiments herein, a radio algorithm may provide a list of APs to be considered for each UE's serving AP group. A routing algorithm may find packet routing paths from a source node, e.g., CPU, to the destination node, that is, the serving AP(s), to serve each UE, possibly in a predetermined priority order, and may report success and/or failures regarding which serving APs may have been connected for each UE. The radio algorithm may then use the reported completed subgroups information, e.g., connected serving AP list or serving AP connection failures, to modify the original, that is, UE-centric, groups and perform weight computation for those modified AP groups.

This approach may be understood to be general and may be used for routing for UL combining as well.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

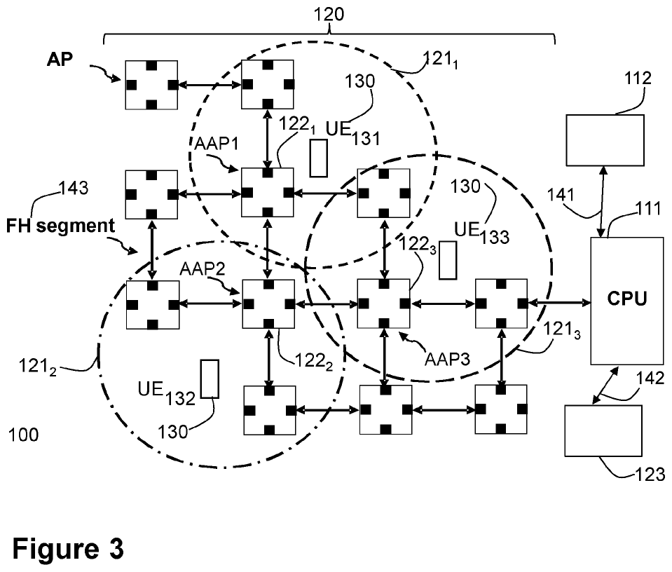

FIG. 3 depicts a non-limiting example of a communications network 100, in some examples also referred to as a wireless communications system, cellular radio system, or cellular network, in which embodiments herein may be implemented. The communications network 100 may typically be a 5G system, 5G network, NR-U or Next Gen System or network, Licensed-Assisted Access (LAA), or MulteFire. In particular embodiments, the communications network 100 may be a D-MIMO network, e.g., a D-MIMO network with segmented fronthaul. The communications network 100 may support or be a younger system than a 5G system, such as, for example a 6G system. The communications network 100 may support other technologies, such as, for example Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, etc. Other examples of other technologies the communications network 100 may support may be Wideband Code Division Multiple Access (WCDMA), Universal Terrestrial Radio Access (UTRA) TDD, Global System for Mobile Communications (GSM) network, Enhanced Data Rates for GSM Evolution (EDGE) network, GSM EDGE Radio Access Network (GERAN) network, Ultra-Mobile Broadband (UMB), network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), IoT, Narrowband Internet of Things (NB-IoT), or any cellular network or system.

Thus, although terminology from 5G/NR and LTE may be used in this disclosure to exemplify embodiments herein, this should not be seen as limiting the scope of the embodiments herein to only the aforementioned systems.

It may be understood that the layout of the communications network 100 depicted in FIG. 3 is a non-limiting example.

As depicted in FIG. 3, the communications network 100 comprises a first network node 111 and a second network node 112. Any of the first network node 111 and the second network node 112 may be understood, respectively, as a first computer system and a second computer system. In some examples, any of the first network node 111 and the second network node 112 may be implemented as a standalone server in e.g., a host computer in the cloud. Any of the first network node 111 and the second network node 112 may in some examples be a distributed node or distributed server, with some of their respective functions being implemented locally, e.g., by a client manager, and some of its functions implemented in the cloud, by e.g., a server manager. Yet in other examples, any of the first network node 111 and the second network node 112 may also be implemented as processing resources in a server farm.

Any of the first network node 111 and the second network node 112 may be a CPU in the communications network 100, or a node connected to the CPU in the communications network 100.

In some non-limiting examples, any of the first network node 111 and the second network node 112 may be a radio network node. As a radio network node, any of the first network node 111 and the second network node 112 may be a transmission point such as a radio base station, for example a gNB, an eNB, or any other network node with similar features capable of serving a wireless device, such as a user equipment or a machine type communication device, in the communications network 100. In typical examples, any of the first network node 111 and the second network node 112 may be a base station, such as a gNB. In other examples, any of the first network node 111 and the second network node 112 may be a distributed node, such as a virtual node in the cloud, and may perform its functions entirely on the cloud, or partially, in collaboration with a radio network node.

The first network node 111 may be understood as a network node having a capability to obtain and analyze radio information pertaining to the communications network 100.

The second network node 112 may be understood as a network node having a capability to obtain and analyze routing information pertaining to the communications network 100.

In some embodiments, the first network node 111 and the second network node 112 may be independent and separated nodes, as depicted in the non-limiting example of FIG. 3. In one embodiment, the method performed by the first network node 111, which may be referred to herein as a “radio algorithm”, may be executed in one hardware block or unit and the method performed by the second network node 112, which may be referred to herein as a “the routing algorithm” may be performed in another, e.g., in different DSPs or other processors. In such an embodiment, the first network node 111 and the second network node 112 may communicate over a physical interface, e.g., an inter-chip/module interface on circuit boards or an inter-unit interface with plugged cables. In another embodiment, any of the first network node 111 and the second network node 112 may be co-located or be the same node. In such an embodiment, the radio and routing algorithms may be executed in logically separated SW units in the same HW/computational block and passed over an API or another SW interface. All the possible combinations are not depicted in FIG. 3 to simplify the Figure.

The communications network 100 may cover a geographical area, which in some embodiments may be divided into coverage areas, wherein each coverage area may be served by a radio network node, although, one radio network node may serve one or several coverage areas. In the example of FIG. 3. As a radio network node, any of the first network node 111 and the second network node 112 may be of different classes, such as, e.g., macro eNodeB, home eNodeB or pico base station, based on transmission power and thereby also coverage area size. In some examples, as a radio network node, any of the first network node 111 and the second network node 112 may serve receiving nodes with serving beams. Any of the first network node 111 and the second network node 112, e.g., as radio network node, may support one or several communication technologies, and its name may depend on the technology and terminology used. Any of the first network node 111 and the second network node 112 may be directly connected to one or more core networks.

The communications network 100 comprises a set of nodes 120. Any of the nodes in the set of nodes 120 may be understood to be an Access Point (AP). An AP may be understood as a hardware unit with transmission/reception capability comprising at least an antenna panel and radio circuitry, and a fronthaul connection via at least one segment. An AP may be also referred as an APU or TRP. Any reference herein to a “node” may be understood to refer to a node in the set of nodes 120, e.g., an AP. In typical embodiments, each of the nodes in the set of nodes 120 may be an AP. The set of nodes 120 may be interconnected and configured in such a way that more than one panel may cooperate in coherent decoding of data from a given device, of the one or more devices comprised in the communications network and described below, and more than one panel may cooperate in coherent transmission of data to a device, of the one or more devices comprised in the communications network 100. The set of nodes 120 may comprise a respective first subset of nodes 121. The respective first subset of nodes 121 may be understood as a group of nodes, out of the set of nodes 120, which may be able to serve a respective device of one or more devices 130 comprised in the communications network 100. That is, one respective first subset of nodes 121 may be understood to be the nodes in the set of nodes 120 which may provide radio coverage to a respective device of the one or more devices 130 comprised in the communications network 100. Hence, the set of nodes 120 may comprise a plurality of respective first subsets of nodes 121, one respective first subset of nodes 121 for every device of the one or more devices 130. In the non-limiting example of FIG. 3, the first subset of nodes 121 comprises a first respective first subset of nodes 121₁ providing coverage to a first device UE₁, a second first respective subset of nodes 121₂, providing coverage to a second device UE₂, and a third first respective subset of nodes 121₃, providing coverage to a third device UE₃.

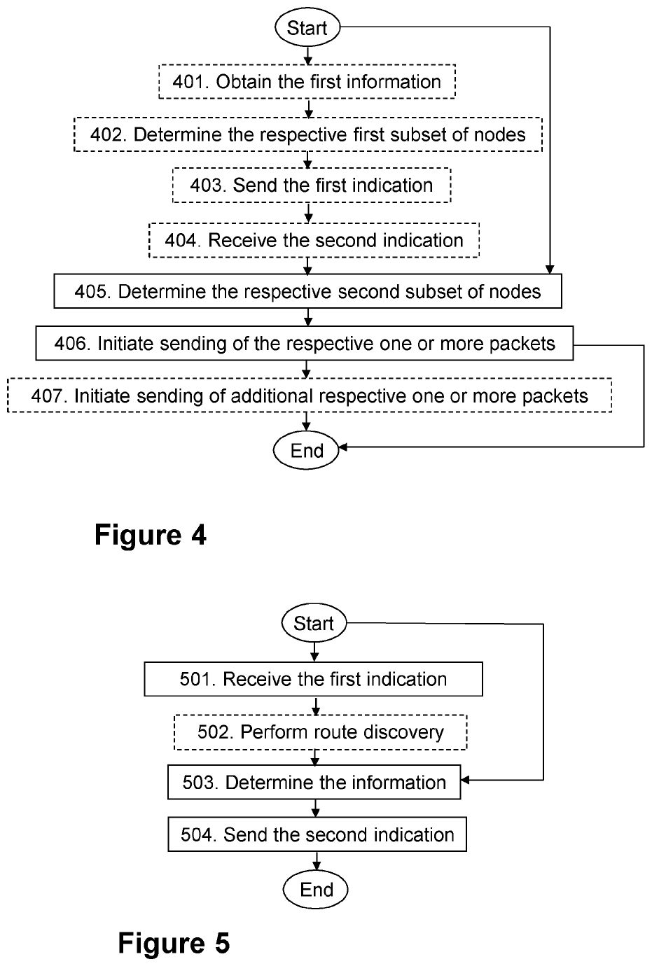

The set of nodes 120 may also comprise a respective subset of nodes 122. The respective subset of nodes 122 may be understood to comprise, out of the respective first subset of nodes 121, one node which may be chosen per device, as will be described herein in relation to FIGS. 4 and 5, to coordinate transmission to the respective device under the radio coverage of a respective first subset of nodes 121. Hence, the respective second subset of nodes 122 may comprise a plurality of “second nodes”, one second node for every device of the one or more devices 130.

An example layout of the communications network 100 wherein embodiments herein may be implemented is shown in FIG. 3, which depicts a preferred example where each device of the one or more devices may be assigned serving nodes, e.g., APs, of the set of nodes 120, and an aggregating node, e.g., AP, (AAP). An aggregating node, e.g., AAP, may be understood as a node which may receive the data packets for a respective device from a respective source node, e.g., the CPU, and distribute them further to additional serving nodes, e.g., APs, of the set of nodes 120. This way, the amount of unique packets to be routed may be reduced compared to the number of individual respective source node-node pairs per device. In other words, an AAP may be understood as an aggregation point for a respective first subset of nodes 121 that may be serving a certain device, at least receiving the data to be served and distributing it to the other serving nodes in the respective first subset of nodes 121. In the non-limiting example of FIG. 3, the respective second subset of nodes 122 comprises a first second node 122₁ providing coverage to the first device UE₁, a second second node 122₂, providing coverage to the second device UE₂, and a third second node 122₃, providing coverage to the third device UE₃. In this non-limiting example, and for illustrative purposes only, the respective second set of nodes 112 is the same as the aggregating nodes for each respective device.

In some embodiments, a composition of the respective second subset of nodes 122 may be different than the respective first subset of nodes 121.

In some embodiments, one of the following two options may apply. According to a first option, a size of the respective second subset of nodes 122 may be smaller than the respective first subset of nodes 121. According to a second option, the size of the respective second subset of nodes 122 may be greater than the respective first subset of nodes 121 by adding additional nodes not present in the respective first subset of nodes 121.

Whether a node of the set of nodes 120 may be comprised in the first subset of nodes 121 or in the respective subset of nodes 122 may vary from time to time and from device to device. Individual nodes of the set of nodes 120, as shown in FIG. 3, may be comprised in more than one respective first subset of nodes 121. Also, although not depicted in the figure, more than one device may share the same second node.

The communications network 100 further comprises a respective source node 123. The respective source node 123 may be understood as a node which may be the origin of respective one or more packets to be sent to a respective device of the one or more devices 130. In other words, the respective source node 123 may be a node where the respective one or more packets, e.g., downlink data, may arrive, e.g., from a backhaul connection, for distribution to the serving nodes of the set of nodes 120, via the fronthaul network of the communications network 100. In typical examples, the respective source node 123 may be co-localized or be the same node as the first network node 111, e.g., a CPU of a D-MIMO network. In the non-limiting example depicted in FIG. 3, the respective source node 123 is depicted as a separate node from the first network node 111.

The one or more devices 130 may be comprised in the communications network 100, whereof three devices, the first device UE₁, the second device UE₂, and the third device UE₃ are depicted in the non-limiting examples of FIG. 3. Any of the one or more devices 130 comprised in the communications network 100 may be a wireless device or wireless communication device such as a 5G UE, or a UE, which may also be known as e.g., mobile terminal, wireless terminal and/or mobile station, a Customer Premises Equipment (CPE) a mobile telephone, cellular telephone, or laptop, e.g., with wireless capability, just to mention some further examples. Any of the one or more devices 130 comprised in the communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, IoT device, sensor, or any other radio network unit capable of communicating over a radio link in a communications system. Any of the one or more devices 130 comprised in the communications network 100 may be enabled to communicate wirelessly in the communications network 100. The communication may be performed e.g., via a RAN, and possibly the one or more core networks, which may be comprised within the communications network 100.

The first network node 111 may be configured to communicate within the communications network 100 with the second network node 112 over a first link 141, e.g., a radio link, for example a first beam, or a wired link. The first network node 111 may be configured to communicate within the communications network 100 with the respective source node 123 over a second link 142, e.g., a radio link, for example a first beam, or a wired link. Any of the nodes in the set of nodes 120 may be configured to communicate within the communications network 100 with nodes in the set of nodes 120 or with the first network node 111 over a respective third link 143, e.g., a radio link or a wired link, which may be understood to be a respective FH segment.

In general, the usage of “first”, “second”, and/or “third” herein may be understood to be an arbitrary way to denote different elements or entities, and may be understood to not confer a cumulative or chronological character to the nouns they modify.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

Embodiments of a method performed by the a first network node 111, will now be described with reference to the flowchart depicted in FIG. 4. The method may be understood to be for handling the set of nodes 120 providing a segmented front-haul. The first network node 111 operates in the communications network 100.

Several embodiments are comprised herein. In some embodiments all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first network node 111 is depicted in FIG. 4. Some actions may be performed in a different order than that shown in FIG. 4.

In FIG. 4, actions which may be optional in some examples are depicted with dashed boxes.

### Action 401

Embodiments herein may be understood to be applied in a communications network such as the communications network 100, e.g., a distributed MIMO network, with the segmented fronthaul. In such a network, fronthaul/backhaul/transport may be provided to a central unit, e.g., a CPU, that may connect to a segmented interconnected fronthaul network that may connect to the set of nodes 120, e.g., individual APs. The segments may implement wired or wireless connections. In either case, the capacity or effective bandwidth of the segments may be determined or estimated. The first network node 111 may be co-localized or be the same as the CPU. The nodes in the set of nodes 120, e.g., APs, may not be reachable directly by the CPU, but via one or, typically, more segments. There may be multiple options to connect the nodes in the set of nodes 120 to the CPU and the segmented option may be used over the coverage area to connect them. Once deployed, the nodes in the set of nodes 120 and the FH network may be tightly integrated.

Embodiments herein may be understood to aim to solve the task of distributing respective one or more packets, e.g., DL data packets, from the respective source node 123, e.g., the CPU, to multiple serving nodes of the set of nodes 120, e.g., APs, per device, e.g., UE, of the one or more devices 130, where the packets in single or multi streams may need to be distributed to all serving nodes of the set of nodes 120, that may subsequently perform precoded data transmission to the respective device. The one or more packets may include encoded binary data, modulated symbol indices, or, in some embodiments, uncoded binary data packets.

In this Action 401, the first network node 111 may obtain a first type of information referred to herein as first information. The first information may enable the first network node 111 to know which devices may be scheduled and which nodes of the set of nodes 120 may be available to deliver the one or more packets to a respective device of the one or more devices 130.

The first information may comprise system and scheduling information. The first information may indicate: i) the one or more devices 130, ii) a respective characteristic of the nodes in the set of nodes 120, and iii) interconnectivity among the set of nodes 120.

In some embodiments, at least two of the one or more devices 130 may be co-scheduled. In other words, the at least two of the one or more devices 130 may be scheduled simultaneously, in the same time/frequency resources, and signals may be separated spatially, the MIMO principle. In some examples, the first information indicating the one or more devices 130 may comprise information about the co-scheduled devices, e.g., their identities, and e.g., optionally, in addition, their data rates. In some particular examples, the first information may comprise information about the co-scheduled devices and characteristics, e.g., locations, of the nodes in the set of nodes 120 in the communications network 100. The first information may additionally or alternatively comprise channel quality estimates, instantaneous or average, with respect to all or a large number of nodes in the communications network 100 for the one or more devices 130.

Obtaining may be understood as determining, deriving, calculating, retrieving, e.g., from a memory storage, and/or receiving, e.g., from any of the one or more devices 130, any of the nodes in the set of nodes 120, and/or another node comprised in the communications network 100. The first information regarding the co-scheduled devices of the one or more devices 130 may for example be obtained from the scheduler in the central node for the distributed MIMO network, or a relevant network segment. The scheduler, and/or associated algorithms such as link adaptation and channel estimation with respect to multiple nodes in the communications network 100 may also provide channel quality estimates, instantaneous or average, with respect to all or a large number of nodes in the communications network 100 for the one or more devices 130. The first information may be available from the radio scheduler or the core network.

The first information indicating the respective characteristics of the nodes in the set of nodes 120 may comprise, for example, a physical location of the serving nodes for each of the one or more devices 130, or virtual locations characterized by their respective link qualities with respect to each device the one or more devices 130.

The interconnectivity among the set of nodes 120 may be obtained via the adjacency matrix of the set of nodes 120, indicating for each node, its connected neighbors and connection segment capacities. The matrix may be constant over time for a given network deployment. Alternatively, it may variable and updated over time, e.g., when the nodes may be mobile and wireless FH connections may be used. Examples of wired segment capacities as of 2021 may be on the order of several Gbps or 5-10 UE packets per radio slot. The first information may be available as fixed system design information or extracted from the current system configuration.

In a preferred example, the co-scheduled device set and device positions may be considered long-term, or at least not changing over multiple radio Transmission Time Intervals (TTIs), e.g., slots, so that the grouping and routing approaches may be used for an extended time. This may be understood to be feasible when the one or more devices 130 may not be highly mobile and may not move significantly during the co-scheduling time scale.

By obtaining the first information in this Action 401, the first network node 111 may then be enabled to know which devices may be scheduled and which nodes of the set of nodes 120 may be available to deliver the one or more packets to the respective device of the one or more devices 130. The first network node 111 may then use the first information, e.g., about the co-scheduled devices, characteristics, e.g., locations of set of nodes 120 in the communications system 100 and about inter-node connections in the fronthaul network, for the task of grouping the nodes, as will be described in Actions 402 and 405.

By obtaining the first information in this Action 401, the first network node 111 may also be enabled to provide the first information, e.g., about inter-node connections in the fronthaul network, to the second network node 112, thereby enabling the second network node 112 to then use this first information for the routing task.

### Action 402

In this Action 402, the first network node 111 may determine, based on the obtained first information, the respective first subset of nodes 121. That is, in this Action 402, the first network node 111 may perform an initial grouping of nodes, out of the set of nodes 120 which may be able to serve a respective device of the one or more devices 130. Respective may be understood to mean that a first subset of nodes 121 may be determined for one device of the one or more devices 130, for example, one of the co-scheduled devices.

Determining may be understood as calculating, deciding or deriving.

The respective first subset of nodes 121, e.g., initial serving AP group, for each scheduled device may be determined in this Action 402 to fulfill one or more first criteria, e.g., one or more first constraints. For example, the respective first subset of nodes 121 may be determined in this Action 402 using known methods to maximize a radio performance metric, e.g., cell/system throughput (TP) or spectral efficiency (SE), average user TP, or some user TP percentile. The selection of the respective first subset of nodes 121 may be based on e.g., selecting a set of N serving nodes with best channel conditions with respect to the respective device, e.g, average or instantaneous signal strength or SINR, where N may be a predetermined sub-group, e.g., 2, 3, as depicted for example in FIGS. 3, 4, 6, 10 etc. Other criteria may be used, e.g., physical distance of the respective device from the nodes in the set of nodes 120. The evaluated radio-related parameters, e.g., link quality, distance, channel correlation, etc., for device-node pairs and inter-node radio properties, e.g., spatial separation or of nodes, may be stored to be used later, in Action 405. The respective first subset of nodes 121 may further be subject to a constraint that a particular node, e.g., AP, may not be allowed to serve more than M devices.

The respective first subset of nodes 121 may be referred to herein as the initial grouping of serving nodes for each device or also as the first sets of serving APs. In examples considered here, the initial grouping of the respective first subset of nodes 121 for K co-scheduled devices may provide K respective first subsets of nodes 121, that is, K groups or sets of APs, one per device.

In one example, referred to as Example A from here on, the respective first subsets of nodes 121 for K devices may be provided as K sets of N nodes, e.g., APs. That is, each device may be associated with a set of exactly N serving nodes, where N may be understood as the preferred group size based on radio performance or other processing considerations.

In another example, Example B, the initial grouping in this Action 402, may determine a group of possible serving nodes for each device where the size of the initial group may be larger than the number of devices that may need to be actually connected, leaving a possibility to connect N nodes, even if some nodes in the respective first subset of nodes 121 cannot be connected. The respective first subsets of nodes 121 may thus comprise K sets of N′ nodes, one per device, where N′>N, and may be N′=Ntot, the total number of nodes in the set of nodes 120. The list may be ordered from best to worst link quality for the respective device. In some scenarios, e.g., pure Line of Sight (LoS), this may correspond to ordering from the closest node to the farthest one. The value of N′, or which fraction of the available Ntot nodes, which may be presented as potential serving nodes for a respective device, may be based on the total number of nodes in the set of nodes 120, FH segment capacity values, average routing failure rate from pervious routing discovery operations, or other routing constraints.

By determining the respective first subset of nodes 121 in this Action 402, the first network node 111 may be enabled to know, for each device of the one or more devices 130, which group of nodes out of the set of nodes 120 may be able to serve the respective device. In other words, a list of nodes to be considered for each device's serving node group. This may then provide a basis to further improve the delivery of the respective one or more packets to the respective device, by further adapting, e.g, pruning or enlarging, the respective first subset of nodes 121 for each device, as will be described in Action 405.

### Action 403

In this Action 403, the first network node 111 may send a first indication to the second network node 112. The first indication may indicate the determined respective first subset of nodes 121.

In some examples, the first network node 111, in this Action 403 may convey to the second network node 112 a priority order for determining of routing paths and the second network node 112 may then perform routing in the priority order. The priority order may be, e.g., “level 1 first for all devices, then level 2-node 1 for all devices, level 2-node 2, etc.”.

Sending may comprise, e.g., providing or outputting, or transmitting, e.g., via the first link 141.

By sending the determined respective first subset of nodes 121 to the second network node 112 in this Action 403, the first network node 111 may enable the second network node 112 to perform route discovery to determine routing paths for distributing the one or more packets, e.g., DL transmission data, from the respective source node 123, e.g., a central node, to the serving nodes, and the to determine respective routing information, as described later in Action 502, for example based on segment capacity limitations. The respective routing information may be understood as, for every device of the one or more devices 130, the paths or routes that may be used to forward the respective one or more packets, e.g., data packets, for each co-scheduled device from the respective source node 123 to the serving nodes of the determined respective first subsets of nodes 121. In other words, the first network node 111 may enable the second network node 112 to find packet routing paths from the respective source node 123, e.g., CPU, to the destination node, that is, the serving node(s), to serve each device, possibly in a predetermined priority order, and e.g., report success and/or failures regarding which serving nodes may have been connected for each device.

### Action 404

In this Action 404, the first network node 111 may receive, responsive to the sent first indication, a second indication from the second network node 112. The second indication may indicate information indicating the respective routing information, as further described later, in Action 502. The information may be based on the determined respective first subset of nodes 121. That the information may be based on the determined respective first subset of nodes 121 may be understood to mean that the second network node 112 may have determined the paths that may be used to forward the respective one or more packets, e.g., data packets, for each co-scheduled device from the respective source node 123 to the serving nodes of the determined respective first subsets of nodes 121, as they may have been indicated by the first network node 111 by sending the first indication in Action 403.

The receiving, e.g., obtaining, may be performed, e.g., via the first link 141.

The information indicating the respective routing information may comprise, for example, a routable path list and/or a routing failure list. In some embodiments, the information may comprise at least one of: for each respective device of the one or more devices 130: i) a respective aggregating node, e.g., AP, receiving the respective one or more packets for the respective device from the respective source node 123 and distributing them further to additional serving nodes, e.g., APs, ii) respective nodes in the set of nodes 120 having experienced a successful connection or failure, e.g., based on whether a routing algorithm run by the second network node 112 may have succeeded in establishing a path to the respective nodes, iii) respective one or more routing paths, iv) respective reasons for connection failure of a node, v) respective alternative routes explored, and vi) respective segment utilization, congestion, failure, and/or availability,

The second indication may be received, for example, as an information element (IE) or data field in a standardized or proprietary information exchange protocol.

By receiving the second indication in this Action 404, the first network node 111 may be enabled to then use this information to perform a dynamic adjustment of the determined respective first subsets of nodes 121, in a way that results in an optimization of the communications in the communications network 100, as will be described in the next Action 405.

### Action 405

In this Action 405, the first network node 111 may modify the grouping of nodes. Particularly, the first network node 111 determines, out of the respective first subset of nodes 121 in the set of nodes 120 to serve a respective device of the one or more devices 130, a respective second subset of nodes 122 to serve each respective device of the one or more devices 130.

The determining in this Action 405 is based on the information obtained from the second network node 112 operating in the communications network 100. The information comprises the respective routing information between the respective source node 123 of the respective one or more packets for the respective device of the one or more devices 130 and the respective device, so that a respective delivery of the respective one or more packets to the respective device of the one or more devices 130 is based on an improvement of one or more metrics. That is, an improvement over what the one or more metrics may have been, had the respective first subset of nodes 121 been used instead of the respective second subset of nodes 122 for the respective delivery. In other words, the first network node 111 may, in this Action 405, use the reported completed subgroups information, connected serving node list or serving node connection failures, to modify the determined respective first subset of nodes 121, that is, the original device-centric groups, according to one or more second criteria, in order to improve the one or more metrics for the respective delivery. The K respective first subsets of nodes 121 may be modified by the first network node 111 based on the routing outcome information to determine the actual set of nodes that may serve as serving nodes to the co-scheduled devices, subject to practical routing limitations in the actual fronthaul network.

In some embodiments, the improvement of the one or more metrics may be one or more of: a) a transmission delay may be reduced by using the second subset of nodes 122 instead of using the first subset of nodes 121, b) a transmission diversity or transmission reliability may be improved by using the second subset of nodes 122 instead of using the first subset of nodes 121; transmission diversity may be understood as enabling transmission to a device from multiple nodes, e.g., APs; transmission reliability may be understood as enabling transmission to a device from, e.g., APs, with good link quality, c) a single user throughput may be improved by using the second subset of nodes 122 instead of using the first subset of nodes 121; the single user throughput may be understood to refer to herein the throughput for a respective device of the one or more devices 130, d) a system throughput may be improved by using the second subset of nodes 122 instead of using the first subset of nodes 121; the system throughput may be understood to refer to herein the aggregate throughput for all devices scheduled in the network, e) a lower amount of inter-user interference may be generated by using the second subset of nodes 122 instead of using the first subset of nodes 121, and f) a lower amount of inter-user interference may be generated by using the second subset of nodes 122 instead of using the first subset of nodes 121; the inter-user interference may be understood as the interference caused by one device on another device of the one or more devices 130.

The determining in this Action 405 of the respective second subset of nodes 122 comprise adjusting the respective delivery of the respective one or more packets to the respective device of the one or more devices 130 based on at least one of: i) one or more respective constraints in a communication interface between the respective source node 123 and the respective device, ii) a communication capacity constraint of the segmented front-haul, and iii) nodes having experienced connection failure for the respective device. According to the first option, the one or more respective constraints in a communication interface between the respective source node 123 and the respective device may be understood to refer to e.g., information exchange latency between these nodes. According to the second option, the communication capacity constraint of the segmented front-haul may be understood to refer to the peak or average data rate or maximum amount of data that may be moved across a segment during a time unit. According to the third option, the nodes having experienced connection failure for the respective device may be understood to refer to routing failures from previous routing discovery operations. A connection or routing failure may be understood as an inability to provide a routing path to the node due to e.g., lack of communication resources in one or more segments that may be required for establishing such a path.

In some embodiments, the determining in this Action 405 of the respective second subset of nodes 122 may comprise determining a plurality of respective second subsets of nodes 122 for at least one of the one or more devices 130. Each respective second subset of nodes 122 in the plurality may be adjusted based on a respective constraint. In other words, for every device, different respective second subsets of nodes 122 may be determined, each optimized for a particular constraint, e.g., a particular type of metric.

In some embodiments, the one or more respective constraints may comprise at least one of: latency, segment capacity, e.g., a segment capacity limitation, spatial diversity and maximum path length.

As described earlier, in some embodiments, the composition of the respective second subset of nodes 122 may be different than the respective first subset of nodes 121.

In some embodiments, one of the following two options may apply. According to a first option, the size of the respective second subset of nodes 122 may be smaller than the respective first subset of nodes 121. That is, the first network node 111 may prune the respective first subset of nodes 121, so that the determined respective second subset of nodes 122 may provide improved metrics in the delivery of the respective one or more packets to the respective device. In some examples, the respective routing information may comprise a routing failure list, and the respective second subset of nodes 122 may comprise a pruned subset of the respective first subset of nodes 121.

In Example A, where the K respective first subsets of nodes 121 may be sets of N nodes per device, the respective first subset of nodes 121 for each device may be modified by removing any node that, based on the routing outcome information, may not have been possible to connect as a serving node for the respective device, or more generally, may not have been suitable for respective device. The resulting K respective second subsets of nodes 122, that is, the modified sets, may be defined as second serving sets.

When certain nodes may be not be suitable for a certain device, they may be removed and used for other devices, so that available resources are utilized fully. “Suitable” here may have a broader meaning than “cannot be connected”. The first network node 111 may thus utilize the routing outcome information that may comprise some metric for the first network node 111 to decide how to remove a node, as it may be more beneficial to add this node for a different device. Additionally, there may be also a tradeoff, e.g., depending on the total number of nodes, FH segment capacity values, average routing failure rate from previous routing discovery operations, the choices of N nodes may be different. And alternatively, two or more sets of N nodes, that is, two or more respective second subsets of nodes 122 may be provided to a device, and each cater to certain aspects of the optimization problem. For example, one respective second subset of N nodes 122 of may accommodate a delay constraint, and another respective second subset of nodes 122 may targets capacity, etc.

According to some examples, the respective first subset of nodes 121 may comprise an ordered list of all serving nodes, or exceeding a threshold, for the respective device, the routing information may comprise a routable path list, and the respective second subset of nodes 122 may comprise a set of top entries in the routable path list. In Example B, where the K respective first subsets of nodes 121 may be sets of N′>N nodes per device, the K respective second subsets of nodes 122 may be formed based on routing output and routing outcome information. Each respective second subset of nodes 122, one per device, may contain the up to N nodes that may have been successfully routed for the device; the remaining N′−N APs may not be included in the respective second subset of nodes 122.

As the initial grouping performed in Action 402 may evaluate and/or consider the link quality of a device, this information may be additionally used in the formation process of the respective second subset of nodes 122. Nodes that may have been successfully routed may, based on some requirements, e.g., delay or capacity optimization, be used to fulfill these requirements. The selection of N, or another subset size, nodes from the initial N′ nodes may thus be based on selected criteria, e.g., delay, preferring nodes closer to the device, capacity, preferring nodes with best channel quality, and macro diversity, preferring nodes with largest mutual spatial distance or channel decorrelation. The selection may use stored radio-related information about device-node pairs from Action 402.

In particular examples of embodiments herein, the respective first subset of nodes 121 for a respective device may comprise a fixed number of serving nodes to serve the device based on the sub-group size, the routing information may comprise a routing failure list, and the respective second subset of nodes 122 may comprise a pruned subset of the respective first subset of nodes 121.

In other particular examples of embodiments herein, the respective first subset of nodes 121 may comprise an ordered list of all nodes, or nodes with link quality exceeding a threshold, for the respective device, the routing information may comprise a routable path list, and the respective second subset of nodes 122 may comprise a fixed number of top entries in the routable path list.

According to a second option, the size of the respective second subset of nodes 122 may be greater than the respective first subset of nodes 121 by adding additional nodes not present in the respective first subset of nodes 121. That is, the first network node 111 may expand the respective first subset of nodes 121, so that the determined respective second subset of nodes 122 may provide improved metrics in the delivery of the respective one or more packets to the respective device. In a further example, that may be applied to both Examples A and B, the respective first subset of nodes 121, one of the K respective first subsets of nodes 121, may be updated by adding new nodes which may not be included in the respective first subset of nodes 121, utilizing the routing information and new association options based on spatial diversity of nodes. Spatial diversity may be understood as performing data transmission to a device form multiple nodes, e.g., APs, with uncorrelated link qualities. The additional nodes may be selected based on their link quality to the device, distance from the device, expected routing availability, e.g., segment congestion status along the respective source node 123→node routing path), etc. or other additional routing outcome information described in Action 502. As before, the selection of additional nodes may use stored radio-related information about device-node pairs from Action 402, as well as the routing outcome information from Action 502.

In another example, if all nodes in a respective first subset of nodes 121 of N nodes for a device may not have been able to be connected due to any limitation, e.g., segment capacity, device prioritization, that device may be reallocated in the following co-scheduling update interval, possibly with elevated prioritization to satisfy fairness.

By determining the respective second subset of nodes 122 based on the routing information obtained from the second network node 112 so that the respective delivery of the respective one or more packets is based on the improvement of one or more metrics, the first network node 111 may provide an approach for performing practical device-centric grouping of nodes, e.g., AP grouping for data routing in the communications network 100, e.g., a distributed MIMO network with segmented fronthaul. The first network node 111 may be enabled to perform the grouping in way that out of all the nodes that may be available to serve a particular device for delivery of packets, a customization of the group of nodes may be performed for the routing of the one or more packets, on a device to device basis, so that the one or more metrics of choice may be improved. By the information concerning routing being obtained from the second network node 112, the approach followed by the first network node 111 to perform the grouping of nodes may have a complexity that may barely exceed the complexity of disjoint grouping and routing operations but may perform close to the optimal joint solution.

Embodiments herein may enable to simplify system design and reduce cost and overall complexity by allowing to keep the radio grouping and routing methods, separate. Coordination and alignment may be ensured via cooperation and information exchange without the need for a joint grouping/routing algorithm, which may be understood to otherwise result in a system of high cost and complexity.

### Action 406

In this Action 406, the first network node 111 initiates sending of the respective one or more packets to the respective device of the one or more devices 130 via the determined respective second subset of nodes 122.

Initiating may be understood as triggering, enabling, facilitating or starting.

In some embodiments, the initiating in Action 406 of the sending may comprise at least one of: i) determining precoding weights for at least one of the nodes in the determined second subset of nodes 122, and ii) transmitting the respective one or more packets using the determined precoding weights. That is, the initiating in Action 406 of the sending may comprise at least one of: computing precoding weights, distributing DL data, and performing DL transmission to the one or more devices 130 based on the respective second subset of nodes 122.

The precoding weight determination may be performed using known methods, e.g., matched-filter (MF), Zero-forcing (ZF), minimum mean-square error (MMSE), or related principles, and may be understood to not be a focus of embodiments herein.

### Performing Precoding With Modified Serving Node Sets

The first network node 111 may perform DL precoding according to known techniques using the respective second subsets of nodes 122. This may comprise i) computing precoding weights based on channel estimates and/or interference estimates for the device-node links, ii) routing data packets to the nodes, e.g. over the respective source node 123→aggregating node and aggregating node→node routing stages, iii) using paths found according to the determined routing parameters, such as the determined pipelining and routing slot budget choices, iv) performing modulation, in some embodiments previously applying coding, and v) applying precoding weights. The transmitting of the respective one or more packets using the determined precoding weights may comprise: transmitting the modulated and precoded symbols to the devices in the DL.

By initiating sending of the respective one or more packets to the respective device via the determined respective second subset of nodes 122, the first network node 111 may enable to deliver the respective one or more packets to the respective device while improving the one or more metrics for the respective device and/or for one or more of the other one or more devices 130.

### Action 407

The low-complexity joint node grouping and data routing approach just described may also be applied to UL transmission, where the routing tasks may be the reverse: the received symbol estimates may be first routed from the receiving node to the device's aggregating node, optionally applying incremental combining/accumulation of each node's contribution. The final combined symbol estimate may then be routed from the aggregating node to the respective source node 123, e.g., the CPU, which in the UL case may be understood to be a respective target or destination node. While the order of the routing tasks may differ, as may the size of the one or more data packets, since each soft symbol estimate may require more bits to represent, the principal impact of routing outcomes on the serving node sets that may be supported may be similar, and the principles of the embodiments herein may be equally applied to the UL use case.

In one example, the same serving node selection, of the respective second subsets of nodes 122, may be applied to DL precoding and UL combining, where the routing outcomes may be determined based on sums of UL and DL data packet sizes, or aggregate segments loads explicitly and separately considering DL routing and UL tasks over same segments with limited capacity.

In this Action 407, the first network node 111 may initiate sending of additional respective one or more packets from the respective device of the one or more devices 130 to the respective source node 123 via the determined respective second subset of nodes 122. In other words, the respective second subsets of nodes 122 may be used for subsequent deliveries of additional one or more packets in the UL.

In accordance with the foregoing description, in particular embodiments, at least one of the following may apply: a) at least two of the one or more devices 130 may be co-scheduled, b) the initiating in Action 406 of the sending may comprise at least one of: i) determining precoding weights for at least one of the nodes in the determined second subset of nodes 122, and ii) transmitting the respective one or more packets using the determined precoding weights, c) each of the nodes in the set of nodes 120 may be an AP, d) the communications network 100 may be a d-MIMO network, e) the respective source node 123 may be the CPU of the d-MIMO network, f) the one or more respective constraints may comprise at least one of: latency, segment capacity, spatial diversity and maximum path length, g) the composition of the respective second subset of nodes 122 may be different than the respective first subset of nodes 121, and h) one of: i) the size of the respective second subset of nodes 122 may be smaller than the respective first subset of nodes 121, and ii) the size of the respective second subset of nodes 122 may be greater than the respective first subset of nodes 121 by adding additional nodes not present in the respective first subset of nodes 121.

By initiating the sending of additional respective one or more packets from the respective device of the one or more devices 130 to the respective source node 123 via the determined respective second subset of nodes 122 in this Action 406, the first network node 111 may be enabled to save processing resources, re-using the optimized respective second subsets of nodes 122 for additional deliveries of packets from the same respective devices in the UL.

Embodiments of a method, performed by a network node, such as the second network node 112, will now be described with reference to the flowchart depicted in FIG. 5. The method may be understood to be for handling the set of nodes 120 providing the segmented front-haul. The second network node 112 operates in the communications network 100 comprising the set of nodes 120.

Several embodiments are comprised herein. In some embodiments all the actions may be performed. In some embodiments, three or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the second network node 112 is depicted in FIG. 5. In FIG. 5, actions which may be optional in some examples are depicted with dashed boxes. Some actions may be performed in a different order than that shown FIG. 5.

The detailed description of some of the features described for the method performed by the second network node 112 corresponds to that already provided when describing the method performed by the first network node 111 and will therefore not be repeated here. For example, in some embodiments, the communications network 100 may be, e.g., a distributed MIMO network, with the segmented fronthaul, where fronthaul/backhaul/transport may be provided to a central unit, e.g., a CPU, that may connect to a segmented interconnected fronthaul network that may connect to the set of nodes 120, e.g., individual APs.

### Action 501

In this Action 501, the second network node 112 receives the first indication from the first network node 111 operating in the communications network 100. The first indication indicates the determined respective first subset of nodes 121 in the set of nodes 120 to serve the respective device of one or more devices 130.

Receiving may be performed, e.g., via the first link 141.

### Action 502

In some embodiments, in this Action 502, the second network node 112 may perform route discovery in the respective first subset of nodes 121, to determine respective routing paths for the respective delivery of the respective one or more packets to the respective device of the one or more devices 130 from the respective source node 123.

In this route discovery Action 502, the second network node 112 may run a routing algorithm which may determine the paths that may be used to forward data packets for each co-scheduled device, of the one or more devices 130, from the respective source node 123, e.g., CPU, to the serving nodes, e.g., APs. In one example, applicable to Examples A and B, the second network node 112 may attempt to connect N nodes per device from the determined respective first subset of nodes 121, that is the list of available serving APs, as determined by the first network node 111. Alternatively, e.g., in the case of Example B, the second network node 112 may attempt to connect as many nodes from the determined respective first subset of nodes 121, including more than N nodes, as possible.

Before starting route discovery, routing constraints may be determined for the route discovery utility function. Examples of such constraints may include segment capacity, maximum path length, etc. The routing discovery process may also rely on the determined respective first subset of nodes 121 per device, node adjacency info, etc.

According to some examples of Action 502, determining routing paths may be limited/extended based on the routing metrics, constraints, e.g., for higher maximum path length and segment capacity, utilize more alternative intermediate nodes to discover paths from source to destination.

Different routing approaches may be envisioned. In one example, the routing algorithm may be centralized, where the second network node 112, e.g., the CPU, may have all information about the nodes to be connected for each device, and full adjacency information regarding inter-node connections. The second network node 112 may then a) determine the aggregating node for a respective device, e.g., AAP for the respective device, all required routing paths from the respective source node 123→aggregating node for a respective device, e.g., CPU→AAP, and from the aggregating node for a respective device→rest of the nodes for the respective second subset of nodes 122, e.g., AAP→AP, and b) inform relevant nodes about the routing path assignments.

In a related alternative example, the routing may be determined without the intermediate aggregating node level but considering direct connections from the respective source node 123→node for all serving nodes for each device.

In another, semi-distributed routing example, the second routing level, from the aggregating node for a respective device→rest of the nodes for the respective second subset of nodes 122 may not be performed in the second network node 112, e.g., a CPU, but the second network node 112 may provide the target/serving node information to each aggregating node, whereafter each aggregating node may determine the routing steps from the aggregating node for a respective device→rest of the nodes for the respective second subset of nodes 122 locally, based on adjacency information limited to its neighborhood.

In yet another example, the routing process may be fully distributed, e.g., internet-style/ad-hoc style, where the second network node 112 as CPU may indicate packet target nodes, that is, aggregating nodes and serving nodes, and the actual routing paths may be determined by tentatively traversing candidate paths and identifying paths with available resources, that is, available neighbor nodes and corresponding segments, step-by-step. This approach may be understood to obviate the need for full a-priori adjacency information; the routing may also adapt to variations in inter-AP connectivity.

One example of a routing algorithm that may be used for routing discovery in this Action 502 is provided in a subsection below. It may be understood to demonstrate how the K initial per-device node sets may be used as input to the routing algorithm and providing K lists of actually routed node sets, one per device.

Other routing approaches may be envisioned. Non-exhaustive examples of alternative routing discovery algorithms are described in another, later, subsection under the subheading “Example routing discovery algorithm for Action 502”.

### Action 503

The second network node 112 in this Action 503, determines, responsive to receiving the first indication, for the respective first subset of nodes 121, the information, which may be referred to herein as routing outcome information. The information comprises the respective routing information between the respective source node 123 of the respective one or more packets for the respective device of the one or more devices 130 and the respective device. The information is based on the determined respective first subset of nodes 121. The information enables the first network node 111 to determine, out of the respective first subset of nodes 121, the respective second subset of nodes 122 to serve each respective device of the one or more devices, so that the respective delivery of the respective one or more packets to the respective device of the one or more devices 130 is based on the improvement of the one or more metrics.

In some embodiments, the improvement of the one or more metrics may be one or more of: a) the transmission delay may be reduced, b) the transmission diversity or transmission reliability may be improved c) the single user throughput may be improved, d) the system throughput may be improved, e) the lower amount of inter-user interference may be generated, and f) the lower amount of inter-user interference may be generated.

The information may be determined based on the performed route discovery performed in Action 502.

The information may comprise at least one of: for each respective device of the one or more devices 130: i) the respective aggregating AP receiving the respective one or more packets for the respective device from the respective source node 123 and distributing them further to additional serving APs, ii) the respective nodes in the set of nodes 120 having experienced a successful connection or failure, iii) the respective one or more routing paths, iv) the respective reasons for connection failure of a node, v) the respective alternative routes explored, and vi) the respective segment utilization, congestion, failure, and/or availability.

The determining of the respective second subset of nodes 122 may be enabled to adjust the respective delivery of the respective one or more packets to the respective device of the one or more devices 130 based on at least one of: i) the one or more respective constraints in the communication interface between the respective source node 123 and the respective device, ii) the communication capacity constraint of the segmented front-haul, and iii) the nodes having experienced connection failure for the respective device.

In some embodiments, the determining of the respective second subset of nodes 122 may be enabled to improve the one or more metrics in the plurality of respective second subsets of nodes 122 for at least one of the one or more devices 130. Each respective second subset of nodes 122 in the plurality may be adjusted based on a respective constraint.

### Routing Outcome Information

Regardless of the chosen routing approach in Action 502, the different routing subtasks, e.g., from the respective source node 123→aggregating node for a respective device and from the aggregating node for a respective device→rest of the nodes for the respective second subset of nodes 122 paths, may compete for a finite set of resources over communication interfaces of the segments connecting the nodes in the set of nodes 120. Some paths may be completed, that is, some nodes may be connected to the respective source node 123 for serving their respective device, while some routing tasks may not be completed due to a lack of routing resources over one or more segments. The lack of segment resources may mean e.g., that the bandwidth or capacity of the segment may limit the number of packets that may be transferred over the segment during a time unit, and that completing some routing tasks may have required more packets to transfer over the segment. As a result, some nodes that may have been required to serve a device, may not be able to participate in precoding.

At the output of Action 503, the second network node 112 may determine the routing results, e.g., aggregating node selection and related routing paths for each device's data packets and may provide routing outcome information.

In Example A, the routing outcome information may comprise, for each device, the subset of nodes out of the N determined respective first subset of nodes 121 that may have been successfully connected, that is, a routing path to it may have been successfully found, or alternatively, the subset of nodes whose connections failed, that is, a routing path to it may not have been established due to some segments running out of resources.

In Example B, the routing outcome information may comprise, for each device, the subset of nodes of the N′>N node candidates that may have been connected. A subset for a given device may be smaller than N, e.g., if more than N′−N routing failures may have occurred, size N, or larger than N, e.g., if the routing algorithm may have been configured to connect more than N possible nodes from the list of N′>N devices.

Additional routing information may include segment utilization or segment failure, which segments/how many times/how many segments may be used, node connection failure reasons, alternatives explored by the routing algorithm, which neighbor segments may not be available for the routing for each device, or which connections failed, segment congestion status of individual segments or along the different routing paths from the respective source node 123→rest of the nodes for the respective second subset of nodes 122, etc.

In particular examples of embodiments herein, the priority order for the determining of routing paths may be obtained in Action 502, and the method may further comprise enabling to perform routing in the priority order.

By determining the information comprising the routing information, the second network node 112 may be enabled to find packet routing paths from the respective source node 123, e.g., CPU, to the destination node, that is, the serving node(s), to serve each device, possibly in a predetermined priority order, and report success and/or failures regarding which serving nodes may have been connected for each device.

### Action 504

In this Action 504, the second network node 112 sends the second indication to the first network node 111. The second indication indicates the determined information.

The sending may be performed, e.g., via the first link 141.

In particular embodiments, at least one of the following may apply: a) at least two of the one or more devices 130 may be co-scheduled, b) each of the nodes in the set of nodes 120 may be an AP, c) the communications network 100 may be a d-MIMO network, d) the respective source node 123 may be the CPU of the d-MIMO network, e) the one or more respective constraints may comprise at least one of: latency, segment capacity, spatial diversity and maximum path length, f) the information may comprise at least one of: for each respective device of the one or more devices 130: i) the respective aggregating AP receiving the respective one or more packets for the respective device from the respective source node 123 and distributing them further to additional serving APs, ii) the respective nodes in the set of nodes 120 having experienced a successful connection or failure, iii) the respective one or more routing paths, iv) the respective reasons for connection failure of a node, v) the respective alternative routes explored, and vi) the respective segment utilization, congestion, failure, and/or availability; g) the composition of the respective second subset of nodes 122 may be different than the respective first subset of nodes 121, and h) one of: i) the size of the respective second subset of nodes 122 may be smaller than the respective first subset of nodes 121, and ii) the size of the respective second subset of nodes 122 may be greater than the respective first subset of nodes 121 by adding additional nodes not present in the respective first subset of nodes 121.

By sending the information to the first network node 111, the second network node 112 may enable the first network node 111 to then use this information to perform the dynamic adjustment of the determined respective first subsets of nodes, in a way that may result in the improvement of the one or more metrics.

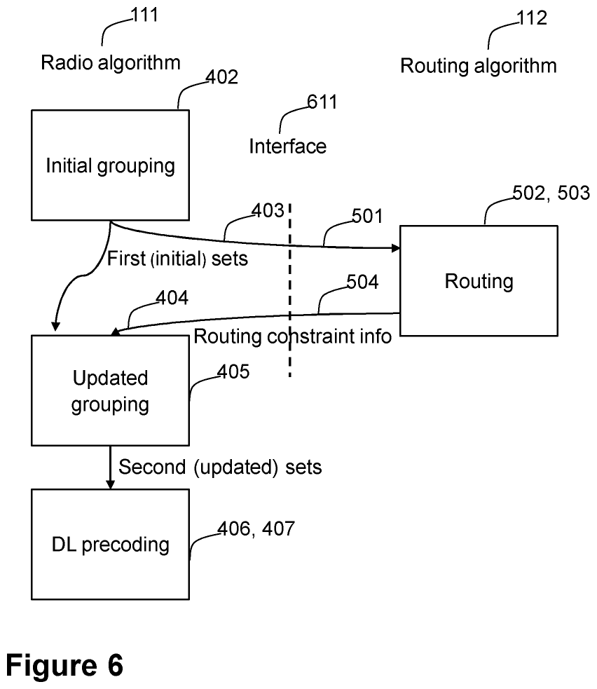

FIG. 6 is a signaling diagram depicting a non-limiting example of a method performed by the first network node 111 and the second network node 112, according to embodiments herein. Under a first approach, the first network node 111 and the second network node 112 may be separated radio and routing unit, respectively. Under the first approach, as an overview of the Actions described in relation to FIG. 4, a non-limiting example of the method performed by the first network node 111 may comprise a method for DL precoding in a “radio unit” in a D-MIMO network with segmented FH, comprising: 1) determining, according to Action 402, first sets of serving APs for one or more UEs, one set per UE; this is depicted in FIG. 6 as “initial grouping”; 2) signaling, according to Action 403, and via an interface 611, the first sets information to a “routing unit”, e.g., a separate hardware or software function in the network, 3) receiving, according to Action 404, the routing outcome information from the “routing unit”, 4) determining, according to Action 405, second sets of serving APs for the one or more UEs based on the first sets and the routing outcome info; this is depicted in FIG. 6 as “updated grouping”; and 5) computing, according to Action 406 and/or Action 407, precoding weights and performing DL transmission to the one or more UEs based on the second sets of serving APs. Under the first approach, as an overview of the Actions described in relation to FIG. 5, a non-limiting example of the method performed by the first network node 111 may comprise a method for AP grouping control in a “routing unit” in the D-MIMO network with segmented FH, comprising: 1) receiving, according to Action 501, the first sets of serving APs for one or more UEs from the “radio unit”, 2) determining, according to Action 502, the routing paths for distributing DL transmission data from a central node (CPU) to the serving APs, 3) providing, according to Action 503, the routing outcome info, based on FH segment capacity limitations, and 4) signaling, according to Action 504, the routing outcome information to the “radio unit”. In any of the methods respectively performed by the first network node 111 and the second network node 112, such as in the example methods of the first approach just described in relation to FIG. 6, one or more of the following options may apply. According to a first option, the routing outcome information may comprise a routing failure list, and the second set may comprise a pruned subset of the first set. According to a second option, the first set may comprise an ordered list of all serving APs, or exceeding a threshold, for the device, the routing outcome information may comprise a routable path list, and the second set comprises a set of top entries in the routable path list. According to a third option, the first network node 111 may convey to the second network node 112 a priority order for determining of routing paths and performing routing in the priority order. According to a fourth option, determining routing paths may be limited/extended based on the routing metrics, constraints,, e.g., for higher maximum path length and segment capacity, utilize more alternative intermediate nodes to discover paths from source to destination.

Under a second approach, the first network node 111 and the second node 112 may be co-localized, be the same node, or be considered as part of a system. Under this second approach, as an overview of the Actions described in relation to FIG. 4 and FIG. 5, a non-limiting example of the method performed by the first network node 111 may comprise a method in a D-MIMO network with segmented FH for DL precoding, comprising: 1) determining, according to Action 404, the first sets of serving APs for one or more UEs, [one set per UE, 2) determining, according to Action 502, the routing paths for distributing DL transmission data from a central node (CPU) to the serving APs and 3) providing, according to Action 504, the routing outcome information, based on segment capacity limitations, 4) determining, according to Action 405, the second sets of serving APs for the one or more UEs based on the first sets and the routing outcome info, and 6) computing, according to Action 406, the precoding weights, distributing DL data, and performing DL transmission to the one or more UEs based on the second sets of serving APs. In any of the methods respectively performed by the first network node 111 and the second network node 112, such as in the example methods of the second approach just described in relation to FIG. 6, one or more of the following options may apply. According to a first option, the first set for a device may comprise a fixed number of serving nodes to serve the device based on the sub-group size, the routing outcome information may comprise a routing failure list, and the seconds set may comprise a pruned subset of the first set. According to a second option, the first set may comprise an ordered list of all nodes, or exceeding a threshold, for the device, the routing outcome information may comprise a routable path list, and the second set comprises a fixed number of top entries in the routable path list. According to a third option, the priority order for the determining of routing paths may be obtained in route discovery step and the method may further comprise performing routing in the priority order. According to a fourth option, the priority order may be, e.g., “level 1 first for all UEs, then level 2-AP1 for all UEs, level 2-AP2, etc.”

### Example Routing Discovery Algorithm for Action 502

In one example of embodiments herein, a two-level routing approach may be used where the packet for a certain device of the one or more devices 130 may be first routed from the respective source node 123, e.g., the CPU, to its aggregating node, e.g., Level 1 (L1), and subsequently, from the aggregating node to additional serving nodes that may be allocated to meet the configured number of nodes per subgroup, e.g., Level 2 (L2). An efficient, feasible joint grouping and routing approach may be established that may allow effectively decoupling the grouping and routing steps.

### Node Routing Orders

A node routing orders may be understood as a sequence in which individual routing tasks may be executed.

As an example of a two-level routing approach, a greedy routing strategy may be used, in the two-level approach, according to which the respective source node 123→aggregating node level may be completed first to maximize the probability of finding aggregating node connections to all devices of the one or more devices 130, followed by the aggregating node→nodes level. The priority order of path routing may be e.g., to perform, respective source node 123→aggregating node routing first for all one or more devices 130, then aggregating node→first additional node for all one or more devices 130, then aggregating node→second additional node for all nodes of the one or more devices 130, etc.

Another priority order may be respective source node 123→aggregating node→serving nodes for all the one or more devices 130, e.g., all UEs that may be scheduled to transmit simultaneously and whose routing solutions may need to coexist in the available fronthaul segment resources, where some example options may include:
respective source node 123→aggregating node→all serving nodes for 1st device, respective source node 123→aggregating node→all serving nodes for 2nd device, . . .
respective source node 123→aggregating node→1^{st} serving node for all devices, respective source node 123→aggregating node→2^{nd} serving node for all devices, . . .
respective source node 123→aggregating node, aggregating node→1st serving node for all devices, aggregating node→2nd serving node for all devices, . . .
respective source node 123→aggregating node, aggregating node→serving all nodes for 1st UE, aggregating node→serving all nodes for 2nd device, . . .

Generally a device may be served by multiple nodes, the 1st serving node may be understood to have the best link, the 2nd serving node may be understood to have the second best etc.

### Routing Timing Configuration

Routing timing configuration may be understood to refer to how to set up the time budgets and resource availability tracking in time for the routing determination step.

The routing approach configuration may be determined or adapted based on deployment parameters, such as e.g., segment BandWidth (BW), number of nodes, node proximity information, . . . , and scenario parameters, e.g., number of devices, average or per-device load, latency, and capacity targets, . . . .

The following adaptations may be used to configure a timing framework and the routing approach.

A first adaptation may be determining length of the routing slot as one or more radio slots, trading off the ability to accommodate larger device sets or route over larger FH network sizes and the target latency and overall network capacity. It may also enable trade-offs between admitting more co-scheduled devices and introducing higher routing delay vs. admitting fewer devices and handling them with a shorter delay.

A second adaptation may be pipelining the routing process, allowing different routing subtasks, e.g., the respective source node 123→aggregating node and aggregating node→node levels, for different radio TTIs to be staggered and share the available resources.

A third adaptation may be configuring a DL routing framework with K subslots, where a single packet may be transferred per segment and subslot, which may enable using traditional routing algorithms to capture time dependencies of transmissions of a packet over adjacent physical segments. A routing framework may be understood as a timing structure for routing solution determination.

This may provide a framework to adapt the routing resources—temporal and hardware-related—to usage scenario, while controlling radio Key Performance Indicator (KPI) impact to improve performance and/or reduce complexity of the routing solution. The virtual segment approach for routing may allow observing and optimizing the details of temporal dependencies of segment usage more easily without requiring a change to traditional routing algorithms. The approach may be described using e.g., the following steps:

### (200) Determining Deployment and Scenario Parameters

The routing configuration may depend on deployment-specific, that is, fixed, and scenario-dependent, that is, time-varying, system parameters.

The routing task of the second network node 112 may use information about the number of nodes in the FH network, the location of the respective source node 123, e.g., the CPU, with respect to the node locations, inter-node connections in the fronthaul node, etc. This may be provided via the adjacency matrix of the respective source node 123, e.g., the CPU and the nodes, indicating for each node its connected neighbors and connection segment capacities. The matrix may be constant over time for a given network deployment. Examples of wired segment capacities as of 2021 may be on the order of several Gbps or 5-10 UE packets per radio slot. This type of information, which may be understood also as first information, may be available as fixed system design information or extracted from the current system configuration. Additionally or alternatively, this type of information may be obtained as first information from the first network node 111.

The first information may comprise information about the co-scheduled devices and locations of the nodes in the set of nodes 120 in the communications network 100. The first information regarding the co-scheduled devices of the one or more devices 130 may for example be provided by the scheduler in the central node for the distributed MIMO network, or a relevant network segment. The scheduler, and/or associated algorithms such as link adaptation and channel estimation with respect to multiple nodes in the communications network 100 may also provide channel quality estimates, instantaneous or average, with respect to all or a large number of nodes in the communications network 100 for the one or more devices 130. Average or per-device load, latency and capacity targets for the devices may also be utilized for routing algorithm configuration. The information may be available from the radio scheduler or the core network.

In a preferred embodiment, the co-scheduled device set and device positions may be considered long-term, or at least not changing over multiple radio TTIs, e.g., slots, so that the grouping and routing approaches may be used for an extended time. This may be understood to be feasible when the one or more devices 130 may not be highly mobile and may not move significantly during the co-scheduling time scale.

### (210) Determining Routing Parameters

Based on the above obtained deployment and scenario parameters, the second network node 112 may determine parameters to be used for deriving a routing approach for data packet forwarding from the respective source node 123, e.g., the CPU to the nodes. The routing parameters dimension and configure the routing algorithm to compute the actual routing paths and their temporal dependencies; in this step 210 the routing paths themselves may be understood to not yet be generated.

The routing parameters, e.g. the routing slot length parameter, a pipelining depth parameter, a pipelining partitioning, etc., may be determined so that a favourable trade-off between resource utilization and system performance may be used, optimized for the current deployment and scenario parameters. Examples of determining specific routing parameters are presented below, under the subheadings “Routing parameter example”.

### (220) Distributing Routing Information

In this optional step, the routing parameters may be distributed from the second network node 112 to additional nodes in the FH network. This may be done e.g., when a distributed or a semi-distributed routing approach may be used. For example, when the entire DL data packet distribution may be performed using ad-hoc routing between individual nodes, the nodes may be configured with relevant parameters and criteria. In another example, when determining the respective source node 123→aggregating node routing stage (L1) may be performed in the respective source node 123 and the aggregating node→node routing stage (L2) may be performed locally in the nodes, the respective source node 123 may pass on relevant routing parameters to the aggregating nodes in a configuration step or along with the forwarded data packet.

### (230) Performing Routing and Precoding

The network, e.g., the second network node 112 or individual aggregating nodes may then execute a routing algorithm to determine paths for DL packet forwarding. The first network node 111 may then perform DL precoding according to known techniques, as described earlier in Action 406.

### Routing Parameter Example: Pipelining Partitioning and Depth

The segment capacity constraint, e.g., expressed as K packets/time unit, may set a physical limit on how many routing steps may be fit into the time unit, in general, not exceeding K. In one example, the radio slot length may be used as the time unit, and a segment may have the capacity of e.g., K=5 packets/radio slot. To perform efficient routing, and/or to make routing over a larger number of hops possible in the first place, it may be possible, and may be necessary, to define a routing time unit, e.g., routing slot length that may be a multiple of the radio slot length. When no Hybrid Automatic Repeat Request (HARQ) retransmissions are applied, the effective transmission time window may be extended to multiple slots while not affecting some radio protocols. The second network node 112 may therefore allow routing one “radio TTI” over >1 slots, or slot groups, if necessary. This may remain transparent to devices, at least regarding the timing of data transmission scheduling signaling and may only impact end-to-end delay. In many use cases, a delay of 2-4 slots, 1-2 ms in Frequency 1 (FR1), less in FR2, may be acceptable.

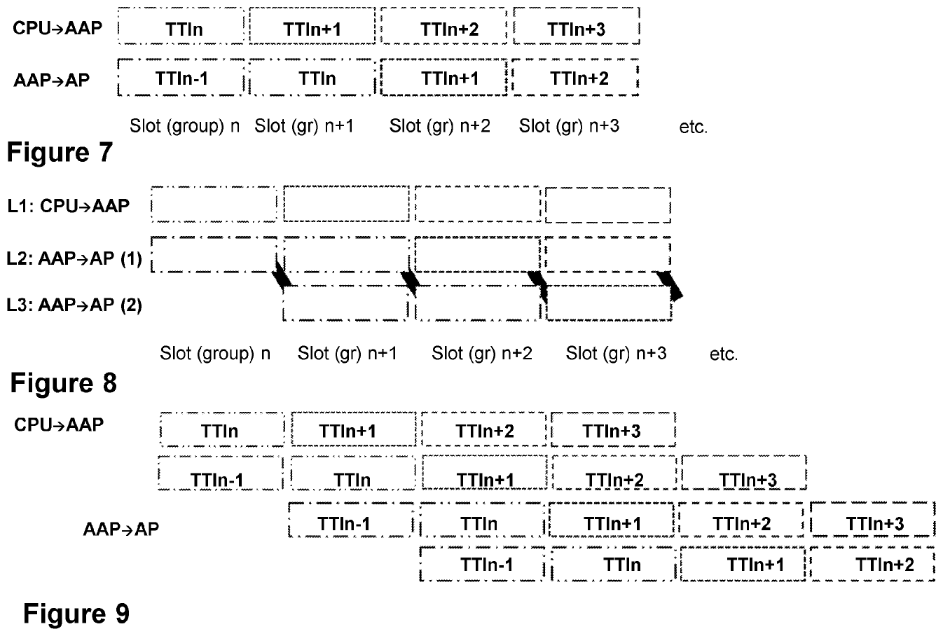

FIG. 7 is a schematic diagram depicting an example of an approach to increase the routing time budget. In the depicted example, the approach may be to decouple the respective source node 123-aggregating node routing level, level 1 or L1, and aggregating node-node routing level, level 2 or L2, and pipeline them over separate, adjacent, slots, or slot groups, that is, Slot (group) n, Slot (group) n+1, Slot (group) n+2, Slot (group) n+3, etc., as depicted. This may remove or reduce concerns about not reaching the aggregating node first during a given slot, e.g., group. The staggered L1/L2 pipeline, indicated in the Figure by TTI number, e.g., n−1, n, n+1, n+2, n+3, etc. may realize a compromise that may allow full data rate per user and improved utilization of segments in all parts of the FH network.

FIG. 8 is a schematic diagram depicting another example of a routing approach, wherein the second network node 112 may allow doubling the routing duration for L2. That is, L2 may be further split into two separate levels, becoming L2 and Layer 3 (L3). This may be understood to ensure fuller utilization of segments for L2, at the cost of increased maximum routing delay.

FIG. 9 is a schematic diagram depicting a variant of the example of FIG. 8, wherein the second network node 112 may double the routing duration for both L1 and L2, thus also increasing the resources for L1 routing.

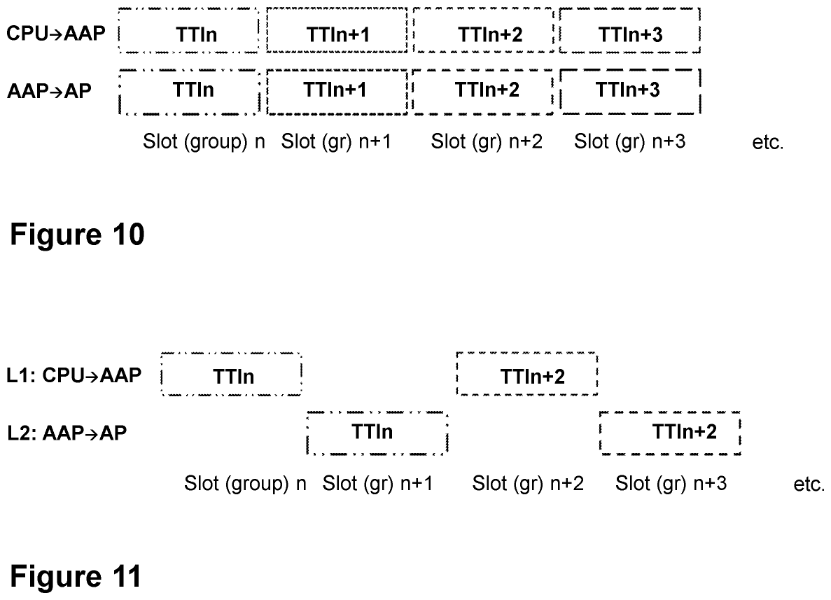

FIG. 10 is a schematic diagram depicting yet another example of a routing approach, wherein no pipelining may be used; L1 and L2 routing steps for a radio TTI may be performed simultaneously. This may lead to a minimal routing delay, but may result in uneven or incomplete utilization of segments in different parts of the FH network.

Overall, a deeper pipelining method may be used to accommodate longer maximum path lengths, or to obtain more full segment utilization. It may increase the transmission delay but may be understood to not affect radio capacity. Since the routing slot length may be understood to not change, there may be no per-slot routing capacity increase or decrease.

In a contrasting example, depicted in the schematic diagram of FIG. 11, Time Division Multiplexing (TDM) of full segment resources may be imposed between L1 and L2 routing tasks, effectively removing pipelining. This may be understood to half per-user data rate/capacity but provide shorter routing paths and may ensure dramatically better connectivity in L2.

According to embodiments herein, these trade-offs may be utilized for scenario-specific adaptation. Some examples of such adaptation may be, e.g.: a) pipelining L1 and L2 routing tasks when the segment utilization may be low, but latency constraints may not be strict, b) increasing pipelining depth for a larger number of co-scheduled devices to further improve segment utilization, c) omitting pipelining when the number of users may be low or latency constraints may be high, d) applying TDM of resources for L1 and L2 routing when the number of co-scheduled users may be particularly high and latency constraints and/or system capacity may be not strained, etc.

### Routing Parameter Example: Subslots and Virtual Segment Configuration

As explained above, for realistic routing, it may be understood to not be sufficient to consider total segment capacity budget. Since segment hardware capacity must be utilized uniformly in time, it may be also necessary to consider the order of packet arrivals at intermediate nodes during the slot, or slot group.

One example of embodiments herein may introduce subslots to allow efficient bookkeeping of their scheduling. Instead of segment capacity K during a slot, segment capacity 1 may be considered during each of K subslots. A slot, or group of L slots, may be divided into K*L subslots and maintain resource bookkeeping as before, but at subslot resolution, allowing one packet per subslot over a segment.

In a greedy algorithm example, a packet may take the next, earliest, available subslot on a required physical segment once it may have arrived at a node. “Later” subslots may be generally more valuable to accommodate late-arriving packets.

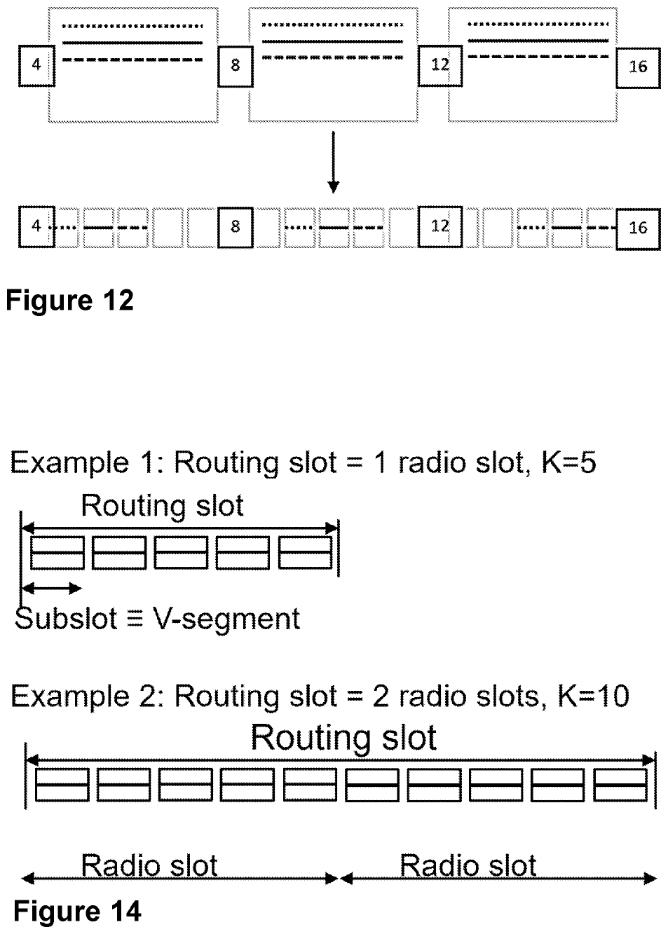

The subslot approach may allow capturing both capacity and time order constraints. The temporal relationship of subslots, compared to overall segment capacity of a slot, is depicted in FIG. 12. Each slot is indicated by a big rectangle, with the wider side on the base. Each subslot is indicated by a small rectangle, with the narrower side on the base, and a line of a respectively different pattern. The numbers 4, 8 and 16 denote non-limiting examples of AP indices.

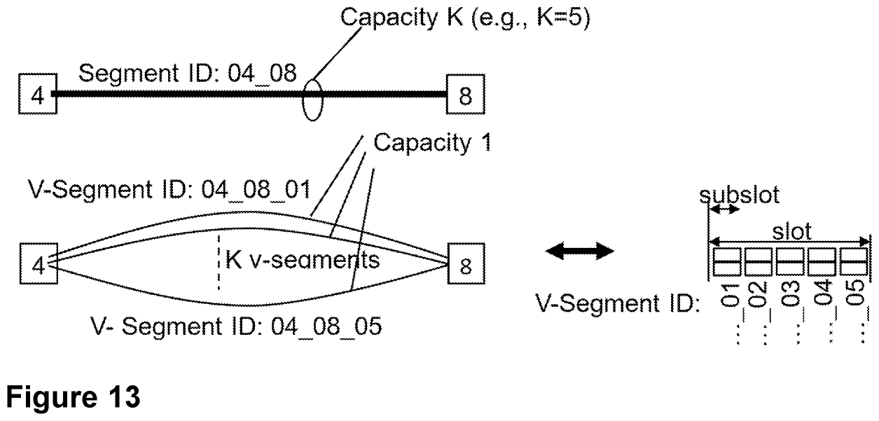

To allow the use of underlying traditional routing algorithms, a related example of embodiments herein may introduce virtual segments (v-segments) to represent fractional, e.g., per-packet, transfer capacities of physical segments. This is schematically illustrated in FIG. 13. The top panel depicts a physical segment, with Segment Identifier (ID) 04_08. One physical segment=K v-segments. In the depicted example, K is 5, each with an ID of 04_08_01, to 04_08_05, and it is schematically represented in the lower panel. The numbers 4 and 8 denote non-limiting examples of AP indices. In this approach, a single physical segment with capacity K, whose residual capacity may be reduced every time it may be utilized by a routing hop, may be replaced by K virtual segments; each used virtual segment may be removed from the resource pool. In other words, instead of using up a “generic” fraction of the capacity per transferred packet that may not capture time sequence aspects, the virtual segments may achieve a time-aware representation since a packet arriving at a node via v-segment_k, e.g., during subslot k, may only be forwarded over v-segments_k+1 and higher, that is, in later subslots. This may be understood to capture time dependencies of packet forwarding over multiple hops during a radio slot.

Each segment may have a different number of v-segments, if optimization of the FH network is desirable. The different number of v-segments may correspond to different FH segment capacity installed between different AP pairs. For example, if a physical segment X is being congested a large fraction of the time, the number of v-segments may be update, e.g., increasing segment capacity, for that X segment.

### Routing Parameter Example: Routing Slot Length

In some deployments and scenarios, the segment capacity constraint may impose an effective routing path length constraint per the same time unit. If it is assumed that segment capacity is K packets/slot, e.g., K=5, then one packet may be passed in 1/K*Tₛₗₒₜ. Assuming that maximum path length of M hops may need to be supported, for a length-M path, each hop may take ≤1/M of the total path time. If M>K, a group of multiple slots, at least ┌M /K┐ may be needed to complete a path.

Furthermore, it may be necessary to consider the order of arriving packets since segment utilization may need to be “spread out” over time. For instance, entire segment capacity, multiple packets, may not be able to be utilized during the last fragment of the slot. It may be therefore necessary to extend the routing slot to multiple radio slots to complete such routing paths.

In one example of embodiments herein, the routing slot length may be varied to control the routing path length and the overall latency. If the routing slot length increases→per-slot routing capacity increases→the second network node 112 may be able to accommodate longer MaxPathLength, or more devices or more packets per device. This may simultaneously increase the transmission delay, and reduce radio capacity, but the second network node 112 may increase the MaxPathLength, that is, the number of segments that may be used from respective source node 123→aggregating node and/or aggregating node→Serving nodes.

In one example of embodiments herein, the size of the respective first subset of nodes 121 may be used as one criterion to determine the routing slot length. Having larger node subgroups, the routing may be more complex and segments may be occupied earlier. So, in case of shorter routing slot length and the corresponding maximum path length, routing may struggle with finding routes to larger AP subgroups. which may limit performance. In that case, the routing slot length may be increased, if the growth in associated routing determination, that is, processing, delay is acceptable.

The total number of segments that may be used in finding a routing path may be understood to be an important parameter. For example, if it is defined as 20, it may mean that the routing path evaluation function may find many alternative paths from aggregating node→Serving nodes. This may increase the routing algorithm delay but may offer a better chance of finding a path from aggregating node→nodes and avoid a node connection failure. Thus, trade-off among delay, packet failure/delivery ratio, and MaxPathLength may be considered. For example, it may be possible to increase routing slot length for a non-delay-sensitive traffic, when the maximum distance between respective source node 123 and nodes may be large, or when the number of devices may be large and the need to fully utilize the segment resources may be high.

In one example of embodiments herein, additional trade-offs may be utilized between admitting more co-scheduled devices and introducing higher routing delay versus admitting fewer devices and handling them with a shorter delay, depending on the network load, the number of active users, and their traffic patterns.

The routing slot length adaptation may be clearly connected to the subslot and v-segment framework. Adaptation of the slot group size and considering capacity K may be combined with V-segment representation to apply the traditional routing principles with simple resource counting and adding only the constraint of which V-segments may be used for subsequent steps.

FIG. 14 is a schematic diagram depicting two different examples, Example 1 and Example 2 of routing slot length adaptation. In both examples, the segment capacity is 5 packets/radio slot. In Example 1, a routing slot corresponds to 1 radio slot, and K is 5. A sub-slot is equivalent to one V-segment. In Example 2, a routing slot corresponds to 2 radio slots, and K is 10.

### Additional Routing Discovery Approaches in Action 502

### Concise Version

Non-exhaustive examples of alternative routing discovery algorithms may include routing protocols for both wired/wireless networks. The routing protocols for wired networks may be classified into adaptive, e.g., Distance Vector Routing, Link State Routing, Routing Information Protocol (RIP), and non-adaptive, e.g., Shortest Path Routing, and Flooding, based on the behavior of the protocol [1-2].

Based on the network administration point of view, the protocols may be classified into interior, e.g., Routing Information Protocol (RIP), Open Shortest Path First (OSPF), and exterior, e.g., Border Gateway Protocol (BGP), and hierarchical routing protocols.

Routing protocols for Mobile Ad hoc Networks may be classified as topology based and position based. The topology based routing protocols may be further classified into three types based on how the routing information may be being updated. They may be table driven or proactive, e.g., Destination Sequenced Distance Vector (DSDV), Optimized Link State Routing (OLSR), Wireless Routing Protocol (WRP), Source Tree Adaptive Routing (STAR), reactive or on demand, e.g., Dynamic Source Routing (DSR), Ad hoc On demand Distance Vector (AODV), Temporally Ordered Routing Algorithm (TORA), Associativity Based Routing (ABR), and hybrid protocols, e.g., Zonal Routing Protocol (ZRP), Core Extraction Distributed Ad hoc Routing (CEDAR). The position based routing protocols'example may be Location Aided Routing (LAR).

Routing techniques in Wireless Sensor Networks (WSN) may be classified based on network topology and protocol operation. The routing strategies may be further classified into query based, multipath based, negotiation based, Location based and QoS based depending on principle of routing operation.

### Extended Version

In more detail, alternative routing discovery algorithms may include several classical proactive/reactive/hybrid ad hoc routing protocols [3] such as On-Demand Distance Vector (AODV), Dynamic Source Routing (DSR), and Temporally Ordered Routing Algorithm (TORA), where their ideas may be borrowed to be adapted for several networks such as cognitive radio ad hoc networks (CRAHN) [4-6]. For instance, in CRAHN, within the SEARCH [7] protocol, path selections may be realized using latency predictions. However, such kind of predictions may induce inaccuracies regarding the spectral dynamics of cognitive radio networks (CRN). The route stability offered by LAUNCH [8] may be based on greedy routing, which may be performed through the selection of the nodes that may be not only closer to the destination, but also less affected due to Primary User (PU) activities. Mobility-Aware Cognitive Routing (MCR) [9] presents a routing protocol, which may employ a Markov predictor in determining the proximity of a node to an interference region. If a node is closer to interference regions, the interference probability within the near future may be higher. Such a prediction model based on the distance may be understood to embody the risk of having a longer routing path, which may have to be avoided. One of the routing methods omitting a mechanism such as routing multiple flows through multiple paths may be OPERA [10], of which main aspects may be optimal shortest path and actual route cost between any source-destination pair.

In addition, there may be several energy-efficient hybrid routing protocols for IoT communication systems in 5G and beyond, such as Power Efficient Gathering in Sensor Information Systems (PEGASIS), Energy-Efficient Unequal Clustering (EEUC), and Energy-Aware Unequal Clustering (EAUCF). Power Efficient Gathering in Sensor Information Systems (PEGASIS) [11] may be understood to use greedy algorithm to construct chains by neighboring nodes. The Cluster Head of the chain at each round may be assigned randomly to forward data to the central station instead of several nodes. Sensors in the chain may rotate among each other to forward data to central station. Energy-efficient unequal clustering (EEUC) [12] has been developed to address the problems associated with WSN hotspots. EEUC may be understood to organize the network into unequal radius cluster, where clusters adjacent to the central station may have smaller radius than those far from the central station. Therefore, a Cluster Head adjacent to the central station may save power for data routing in multi-hop route. The Energy-aware unequal clustering algorithm (EAUCF) [13] may be understood to be an unequal clustering mechanism which may employ the fuzzy techniques, and consider the position of the central station when a cluster group may have been created.

On the other hand, for wired networks, there may be different routing classes, such as Distance Vector, Link State, and Hybrid. Some examples of routing protocols may include RIP, Routing Information Protocol version 2 (RIPv2), Enhanced Interior Gateway Protocol (EIGRP), and Open Shortest Path First (OSPF) [14]. The distance vector [15] routing protocols configured in the router may find the best path to the remote network based on the distance from the router. The distance vector routing protocols may be class-full routing protocols. In such classes, full routing tables may be exchanged and updates may be exchanged through broadcast, e.g., RIP and IGRP. The link state [16] routing protocols may also be called as the shortest path first protocols. The link state routing protocols may consist of three routing tables, neighbor table, topology table and the routing table. The neighbor table may contain details of the directly connected routers. The topology table may contain information about the topology of the entire internetwork. The routing table may consist of the shortest path to the remote networks. The link state routing protocols may be classless routing protocols. As compared to the distance vector, in the link state, only the missing routes may be exchanged. The updates may be exchanged through multicast, e.g., OSPF. The hybrid [15] protocols may be understood to use the aspects of both the distance vector and the link state routing protocols. The hybrid protocols may be understood to be classless routing protocols. In the case of hybrid protocols, only the missing routes may be exchanged between the routers and the updates may be exchanged through multicast, e.g., EIGRP.

Certain embodiments disclosed herein may provide one or more of the following technical advantage(s), which may be summarized as follows. Embodiments herein may enable to simplify system design and reduce cost and overall complexity by allowing to keep the radio grouping and routing methods, separate. Coordination and alignment may be ensured via cooperation and information exchange without the need for a joint grouping/routing algorithm, which may be understood to otherwise result in a system of high cost and complexity.

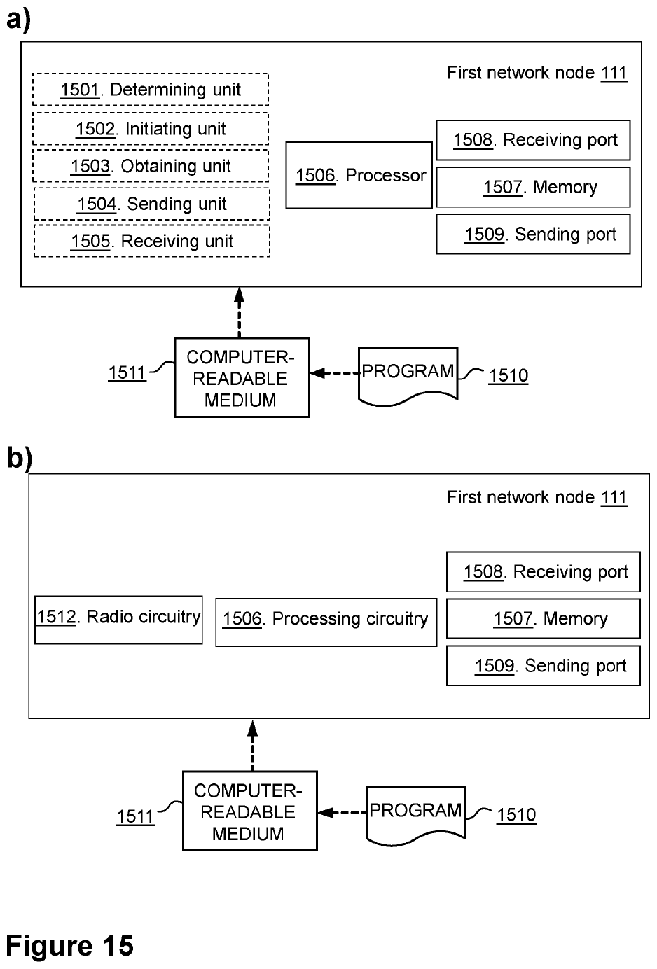

FIG. 15 depicts two different examples in panels a) and b), respectively, of the arrangement that the first network node 111 may comprise. In some embodiments, the first network node 111 may comprise the following arrangement depicted in FIG. 15a. The first network node 111 may be understood to be for handling the set of nodes 120 configured to provide the segmented front-haul. The first network node 111 is configured to operate in the communications network 100 configured to comprise the set of nodes 120.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first network node 111, and will thus not be repeated here. For example, in some embodiments, the communications network 100 may be configured to be, e.g., a distributed MIMO network, with the segmented fronthaul, where fronthaul/backhaul/transport may be provided to a central unit, e.g., a CPU, that may connect to a segmented interconnected fronthaul network that may connect to the set of nodes 120, e.g., individual APs.

The first network node 111 is configured to, e.g., by means of a determining unit 1501 configured to, determine, out of the respective first subset of nodes 121 in the set of nodes 120 to serve the respective device of one or more devices 130, the respective second subset of nodes 122 to serve each respective device of the one or more devices. The determining is configured to be based on the information configured to be obtained from the second network node 112 configured to operate in the communications network 100. The information is configured to comprise the respective routing information between the respective source node 123 of the respective one or more packets for the respective device of the one or more devices 130 and the respective device. The determining is configured to be so that the respective delivery of the respective one or more packets to the respective device of the one or more devices 130 is configured to be based on the improvement of one or more metrics. That is, an improvement with respect to what the one or more metrics would otherwise be, if the first subset of nodes 121 were to be used for the delivery.

The first network node 111 may be configured to perform the receiving of Action 1201, e.g., by means of an initiating unit 1502 configured to initiate sending of the respective one or more packets to the respective device of the one or more devices 130 via the respective second subset of nodes 122 configured to be determined.

In some embodiments, the improvement of the one or more metrics may be configured to be one or more of: i) the transmission delay is configured to be reduced by using the second subset of nodes 122 instead of using the first subset of nodes 121, ii) the transmission diversity or transmission reliability is configured to be improved by using the second subset of nodes 122 instead of using the first subset of nodes 121, iii) the single user throughput is configured to be improved by using the second subset of nodes 122 instead of using the first subset of nodes 121, iv) the system throughput is configured to be improved by using the second subset of nodes 122 instead of using the first subset of nodes 121, v) lower amount of inter-user interference is configured to be generated by using the second subset of nodes 122 instead of using the first subset of nodes 121, and vi) lower amount of inter-user interference is configured to be generated by using the second subset of nodes 122 instead of using the first subset of nodes 121.

In some embodiments, the determining of the respective second subset of nodes 122 may be configured to comprise adjusting the respective delivery of the respective one or more packets to the respective device of the one or more devices 130 based on at least one of: a) the one or more respective constraints in the communication interface between the respective source node 123 and the respective device, b) the communication capacity constraint of the segmented front-haul, and c) the nodes having experienced connection failure for the respective device.

In some embodiments, the determining of the respective second subset of nodes 122 may be configured to comprise determining the plurality of respective second subsets of nodes 122 for at least one of the one or more devices 130, and each respective second subset of nodes 122 in the plurality may be configured to be adjusted based on a respective constraint.

In some embodiments, the first network node 111 may be configured with at least one of the following three configurations.

The first network node 111 may be configured to, e.g., by means of an obtaining unit 1503 configured to, obtain the first information configured to indicate: i) the one or more devices 130, ii) the respective characteristic of the nodes in the set of nodes 120, and c) the interconnectivity among the set of nodes 120.

In some embodiments, the first network node 111 may be configured to, e.g., by means of the determining unit 1501 configured to, determine, based on the first information configured to be obtained, the respective first subset of nodes 121.

The first network node 111 may be configured to, e.g., by means of a sending unit 1504 configured to, send the first indication to the second network node 112. The first indication may be configured to indicate the respective first subset of nodes 121 configured to be determined.

The first network node 111 may be configured to, e.g., by means of a receiving unit 1505 configured to, receive, responsive to the sent first indication, the second indication from the second network node 112. The second indication may be configured to indicate the information configured to indicate the respective routing information. The information may be configured to be based on the respective first subset of nodes 121 configured to be determined.

The first network node 111 may be configured to, e.g., by means of the initiating unit 1502 configured to, initiate the sending of the additional respective one or more packets from the respective device of the one or more devices 130 to the respective source node 123 via the respective second subset of nodes 122 configured to be determined.

In some embodiments, at least one of the following may apply: a) at least two of the one or more devices 130 may be configured to be co-scheduled; b) the initiating of the sending may be configured to comprise at least one of: i) determining the precoding weights for at least one of the nodes in the determined second subset of nodes 122, and ii) transmitting the respective one or more packets using the determined precoding weights; c) each of the nodes in the set of nodes 120 may be configured to be an AP; d) the communications network 100 may be configured to be a d-MIMO network; e) the respective source node 123 may be configured to be the CPU of the d-MIMO network, f) the one or more respective constraints may be configured to comprise at least one of: latency, segment capacity, spatial diversity and maximum path length; g) the composition of the respective second subset of nodes 122 may be configured to be different than the respective first subset of nodes 121, and h) one of: i) the size of the respective second subset of nodes 122 may be configured to be smaller than the respective first subset of nodes 121, and ii) the size of the respective second subset of nodes 122 may be configured to be greater than the respective first subset of nodes 121 by adding additional nodes not present in the respective first subset of nodes 121.

The embodiments herein in the first network node 111 may be implemented through one or more processors, such as a processor 1506 in the first network node 111 depicted in FIG. 15a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The first network node 111 may further comprise a memory 1507 comprising one or more memory units. The memory 1507 is arranged to be used to store obtained information, store data, configurations, schedulings, and applications etc. to perform the methods herein when being executed in the first network node 111.

In some embodiments, the first network node 111 may receive information from, e.g., the second network node 112, the set of nodes 120, the respective source node 123 and the one or more devices 130, through a receiving port 1508. In some embodiments, the receiving port 1508 may be, for example, connected to one or more antennas in first network node 111. In other embodiments, the first network node 111 may receive information from another structure in the communications network 100 through the receiving port 1508. Since the receiving port 1508 may be in communication with the processor 1506, the receiving port 1508 may then send the received information to the processor 1506. The receiving port 1508 may also be configured to receive other information.

The processor 1506 in the first network node 111 may be further configured to transmit or send information to e.g., the second network node 112, the set of nodes 120, the respective source node 123, the one or more devices 130 and/or another structure in the communications network 100, through a sending port 1509, which may be in communication with the processor 1506, and the memory 1507.

Those skilled in the art will also appreciate that the units 1501-1505 described above may refer to a combination of analog and digital circuits, and/or one or more processors configured with software and/or firmware, e.g., stored in memory, that, when executed by the one or more processors such as the processor 1506, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1501-1505 described above may be implemented as one or more applications running on one or more processors such as the processor 1506.

Thus, the methods according to the embodiments described herein for the first network node 111 may be respectively implemented by means of a computer program 1510 product, comprising instructions, i.e., software code portions, which, when executed on at least one processor 1506, cause the at least one processor 1506 to carry out the actions described herein, as performed by the first network node 111. The computer program 1510 product may be stored on a computer-readable storage medium 1511. The computer-readable storage medium 1511, having stored thereon the computer program 1510, may comprise instructions which, when executed on at least one processor 1506, cause the at least one processor 1506 to carry out the actions described herein, as performed by the first network node 111. In some embodiments, the computer-readable storage medium 1511 may be a non-transitory computer-readable storage medium, such as a CD ROM disc, or a memory stick. In other embodiments, the computer program 1510 product may be stored on a carrier containing the computer program 1510 just described, wherein the carrier is one of an electronic signal, optical signal, radio signal, or the computer-readable storage medium 1511, as described above.

The first network node 111 may comprise a communication interface configured to facilitate communications between the first network node 111 and other nodes or devices, e.g., the second network node 112, the set of nodes 120, the respective source node 123, the one or more devices 130 and/or another structure in the communications network 100. The interface may, for example, include a transceiver configured to transmit and receive radio signals over an air interface in accordance with a suitable standard.

In other embodiments, the first network node 111 may comprise the following arrangement depicted in FIG. 15b. The first network node 111 may comprise a processing circuitry 1506, e.g., one or more processors such as the processor 1506, in the first network node 111 and the memory 1507. The first network node 111 may also comprise a radio circuitry 1512, which may comprise e.g., the receiving port 1508 and the sending port 1509. The processing circuitry 1506 may be configured to, or operable to, perform the method actions according to FIG. 4 and/or FIG. 6, in a similar manner as that described in relation to FIG. 15a. The radio circuitry 1512 may be configured to set up and maintain at least a wireless connection with the second network node 112, the set of nodes 120, the respective source node 123, the one or more devices 130 and/or another structure in the communications network 100. Circuitry may be understood herein as a hardware component.

Hence, embodiments herein also relate to the first network node 111 operative to operate in the communications network 100. The first network node 111 may comprise the processing circuitry 1506 and the memory 1507, said memory 1507 containing instructions executable by said processing circuitry 1506, whereby the first network node 111 is further operative to perform the actions described herein in relation to the first network node 111, e.g., in FIG. 4 and/or FIG. 6.

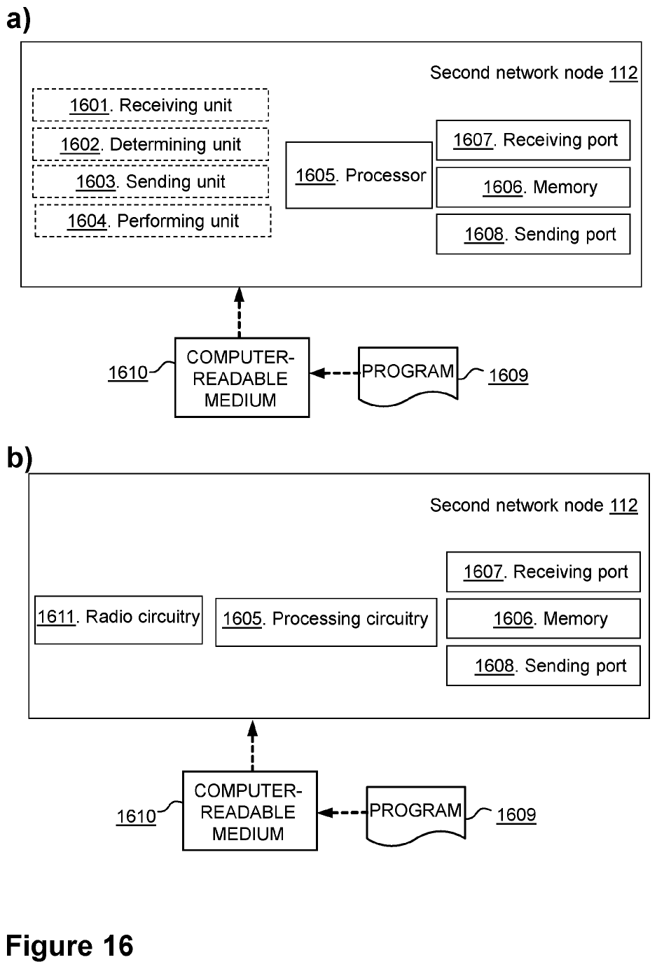

FIG. 16 depicts two different examples in panels a) and b), respectively, of the arrangement that the second network node 112 may comprise. In some embodiments, the second network node 112 may comprise the following arrangement depicted in FIG. 16a. The second network node 112 may be understood to be for handling the set of nodes 120 configured to provide the segmented front-haul. The second network node 112 is configured to operate in the communications network 100 configured to comprise the set of nodes 120.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second network node 112, and will thus not be repeated here. For example, in some embodiments, the communications network 100 may be configured to be, e.g., a distributed MIMO network, with the segmented fronthaul, where fronthaul/backhaul/transport may be provided to a central unit, e.g., a CPU, that may connect to a segmented interconnected fronthaul network that may connect to the set of nodes 120, e.g., individual APs.

In FIG. 16, optional units are indicated with dashed boxes.

The second network node 112 is configured to, e.g., by means of a receiving unit 1601 within the second network node 112 configured to, receive the first indication from the first network node 111 configured to operate in the communications network 100. The first indication is configured to indicate the determined respective first subset of nodes 121 in the set of nodes 120 to serve the respective device of one or more devices 130.

The second network node 112 is also configured to, e.g., by means of a determining unit 1602 configured to, determine, responsive to receiving the first indication, for the respective first subset of nodes 121, the information configured to comprise the respective routing information between the respective source node 123 of the respective one or more packets for the respective device of the one or more devices 130 and the respective device. The information is configured to be based on the respective first subset of nodes 121 configured to be determined. The information is configured to enable the first network node 111 to determine, out of the respective first subset of nodes 121, the respective second subset of nodes 122 to serve each respective device of the one or more devices, so that the respective delivery of the respective one or more packets to the respective device of the one or more devices 130 is configured to be based on an improvement of one or more metrics.

The second network node 112 is further configured to, e.g., by means of a sending unit 1603 configured to, send the second indication to the first network node 111. The second indication is configured to indicate the information configured to be determined.

In some embodiments, the improvement of the one or more metrics may be configured to be one or more of: i) the transmission delay is configured to be reduced, ii) the transmission diversity or transmission reliability is configured to be improved, iii) the single user throughput is configured to be improved, iv) the system throughput is configured to be improved, v) lower amount of inter-user interference is configured to be generated, and vi) lower amount of inter-user interference is configured to be generated.

In some embodiments, the determining of the respective second subset of nodes 122 may be configured to be enabled to adjust the respective delivery of the respective one or more packets to the respective device of the one or more devices 130 based on at least one of: a) the one or more respective constraints in the communication interface between the respective source node 123 and the respective device, b) the communication capacity constraint of the segmented front-haul, and c) the nodes having experienced connection failure for the respective device.

In some embodiments, the determining of the respective second subset of nodes 122 may be configured to be enabled to improve the one or more metrics in the plurality of respective second subsets of nodes 122 for at least one of the one or more devices 130. Each respective second subset of nodes 122 in the plurality may be configured to be enabled to be adjusted based on a respective constraint.

In some embodiments, the second network node 112 may be configured to, e.g., by means of a performing unit 1604 within the second network node 112 configured to, perform route discovery in the respective first subset of nodes 121, to determine respective routing paths for the respective delivery of the respective one or more packets to the respective device of the one or more devices 130 from the respective source node 123. The information may be configured to be determined based on the route discovery configured to be performed.

In some embodiments, at least one of the following may apply: a) at least two of the one or more devices 130 may be configured to be co-scheduled, b) each of the nodes in the set of nodes 120 may be configured to be an AP, c) the communications network 100 may be configured to be a d-MIMO, network, d) the one or more respective constraints may be configured to comprise at least one of: latency, segment capacity, spatial diversity and maximum path length, e) the information may be configured to comprise at least one of: for each respective device of the one or more devices 130: i) the respective aggregating AP configured to receive the respective one or more packets for the respective device from the respective source node 123 and distributing them further to additional serving APs, ii) the respective nodes in the set of nodes 120 configured to have experienced a successful connection or failure, iii) the respective one or more routing paths, iv) the respective reasons for connection failure of a node, v) the respective alternative routes explored, and vi) the respective segment utilization, congestion, failure, and/or availability, f) the composition of the respective second subset of nodes 122 may be configured to be different than the respective first subset of nodes 121, and g) one of: i) the size of the respective second subset of nodes 122 may be configured to be smaller than the respective first subset of nodes 121, and ii) the size of the respective second subset of nodes 122 may be configured to be greater than the respective first subset of nodes 121 by adding additional nodes not present in the respective first subset of nodes 121.

The embodiments herein in the second network node 112 may be implemented through one or more processors, such as a processor 1605 in the second network node 112 depicted in FIG. 16a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second network node 112. One such carrier may be in the form of a CD ROM disc. It is however feasible with other data carriers such as a memory stick. The computer program code may furthermore be provided as pure program code on a server and downloaded to the second network node 112.

The second network node 112 may further comprise a memory 1606 comprising one or more memory units. The memory 1606 is arranged to be used to store obtained information, store data, configurations, schedulings, and applications etc. to perform the methods herein when being executed in the second network node 112.

In some embodiments, the second network node 112 may receive information from, e.g., the first network node 111, the set of nodes 120, the respective source node 123 and the one or more devices 130, through a receiving port 1607. In some embodiments, the receiving port 1607 may be, for example, connected to one or more antennas in second network node 112. In other embodiments, the second network node 112 may receive information from another structure in the communications network 100 through the receiving port 1607. Since the receiving port 1607 may be in communication with the processor 1605, the receiving port 1607 may then send the received information to the processor 1605. The receiving port 1607 may also be configured to receive other information.

The processor 1605 in the second network node 112 may be further configured to transmit or send information to e.g., the first network node 111, the set of nodes 120, the respective source node 123, the one or more devices 130 and/or another structure in the communications network 100, through a sending port 1608, which may be in communication with the processor 1605, and the memory 1606.

Those skilled in the art will also appreciate that the units 1601-1604 described above may refer to a combination of analog and digital circuits, and/or one or more processors configured with software and/or firmware, e.g., stored in memory, that, when executed by the one or more processors such as the processor 1605, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1601-1604 described above may be implemented as one or more applications running on one or more processors such as the processor 1605.

Thus, the methods according to the embodiments described herein for the second network node 112 may be respectively implemented by means of a computer program 1609 product, comprising instructions, i.e., software code portions, which, when executed on at least one processor 1605, cause the at least one processor 1605 to carry out the actions described herein, as performed by the second network node 112. The computer program 1609 product may be stored on a computer-readable storage medium 1610. The computer-readable storage medium 1610, having stored thereon the computer program 1609, may comprise instructions which, when executed on at least one processor 1605, cause the at least one processor 1605 to carry out the actions described herein, as performed by the second network node 112. In some embodiments, the computer-readable storage medium 1610 may be a non-transitory computer-readable storage medium, such as a CD ROM disc, or a memory stick. In other embodiments, the computer program 1609 product may be stored on a carrier containing the computer program 1609 just described, wherein the carrier is one of an electronic signal, optical signal, radio signal, or the computer-readable storage medium 1610, as described above.

The second network node 112 may comprise a communication interface configured to facilitate communications between the second network node 112 and other nodes or devices, e.g., the wireless device 130 and/or another structure in the communications network 100. The interface may, for example, include a transceiver configured to transmit and receive radio signals over an air interface in accordance with a suitable standard.

In other embodiments, the second network node 112 may comprise the following arrangement depicted in FIG. 16b. The second network node 112 may comprise a processing circuitry 1605, e.g., one or more processors such as the processor 1605, in the second network node 112 and the memory 1606. The second network node 112 may also comprise a radio circuitry 1611, which may comprise e.g., the receiving port 1607 and the sending port 1608. The processing circuitry 1605 may be configured to, or operable to, perform the method actions according to FIG. 5 and/or FIGS. 6-14, in a similar manner as that described in relation to FIG. 16a. The radio circuitry 1611 may be configured to set up and maintain at least a wireless connection with the the wireless device 130 and/or another structure in the communications network 100. Circuitry may be understood herein as a hardware component.

Hence, embodiments herein also relate to the second network node 112 operative to operate in the communications network 100. The second network node 112 may comprise the processing circuitry 1605 and the memory 1606, said memory 1606 containing instructions executable by said processing circuitry 1605, whereby the second network node 112 is further operative to perform the actions described herein in relation to the second network node 112, e.g., in FIG. 5 and/or FIGS. 6-14.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

When using the word “comprise” or “comprising” it shall be interpreted as non-limiting, i.e. meaning “consist at least of”.

A processor may be understood herein as a hardware component.

The embodiments herein are not limited to the above described preferred embodiments. Various alternatives, modifications and equivalents may be used. Therefore, the above embodiments should not be taken as limiting the scope of the invention.

### REFERENCES

[1] Chaganti, B. N. L., and R. S. K. Mohan. “Routing Layer Design issues and Protocols for Wired and Wireless Networks.” International Journal of Computer Science And Technology IJCST 7.1 (2016). http://www.ijcst.com/vol71/1/1-chaganti-b-n-lakshmi.pdf
[2] Introduction to Routing Dynamically, Cisco Press, 2014 https://www.ciscopress.com/articles/article.asp?p=2180210&seqNum=7
[3] E. M. Royer and Chai-Keong Toh, “A review of current routing protocols for ad hoc mobile wireless networks,” in IEEE Personal Communications, vol. 6, no. 2, pp. 46-55, April 1999, doi: 10.1109/98.760423.

[4] Salim, S., & Moh, S. (2013). On-demand routing protocols for cognitive radio ad hoc networks. EURASIP Journal on Wireless Communications and Networking, 2013(1), 1-10.
[5] El Garoui, L., Ajib, W., & Elbiaze H. (2014). CO-TORA on demand routing protocol for cognitive radio ad-hoc networks. In: International wireless communications and mobile computing conference (IWCMC). (pp. 654-659), Nicosia, Cyprus.
[6] Joshi, G. P.,Kim, S.W.,&Nam, S.Y. (2015). Routing layer solution for mitigating frequent channel switching in ad hoc cognitive radio networks. IEEE Communications Letters, 19(11), 1917-1920.
[7] Chowdhury, K. R., & Di Felice, M. (2009). SEARCH: A routing protocol for mobile cognitive radio ad-Hoc networks. In: IEEE sarnoff symposium. (pp. 1-6), Princeton, NJ, USA.
[8] Habak, K., Abdelatif, M., Hagrass, H., Rizc, & K., Youssef, M. (2013). A location-aided routing protocol for cognitive radio networks. In: International conference on computing, networking and communications (ICNC). (pp. 729-733), San Diego, USA.
[9] Lee, J. J.,&Lim, J. (2014). Cognitive routing for multi-hop mobile cognitive radio ad hoc networks. Communications and Networks, 16(2), 155-161.
[10] Caleffi, M., Akyildiz, I. F., & Paura, L. (2012). OPERA: Optimal routing metric for cognitive radio ad hoc networks. IEEE Transactions on Wireless Communications, 11(8), 2884-2894.
[11] Baniata, Mohammad, et al. “Energy-efficient hybrid routing protocol for IoT communication systems in 5G and beyond.” Sensors 21.2 (2021): 537.
[12] Li, Chengfa, et al. “An energy-efficient unequal clustering mechanism for wireless sensor networks.” IEEE International Conference on Mobile Adhoc and Sensor Systems Conference, 2005. IEEE, 2005.
[13] Bagci, Hakan, and Adnan Yazici. “An energy aware fuzzy approach to unequal clustering in wireless sensor networks.” Applied Soft Computing 13.4 (2013): 1741-1749.
[14] Kisten, S. Ping-Tsai Chung. “Analysis and experimentation on dynamic routing protocols: EIGRP and OSPF” (Dept. of Computer Science, Long Island Univ., Brooklyn, NY, USA); Source: International Conference on Internet Computing—IC'03, p 591-3 Vol.2, 2003
[15] Rick Graziani and Allan Jonson, “Routing protocols and concepts: CCNA exploration companion guide” Pearson Education. London, 2008.
[16] Todd Lammle, “Cisco Certified Network Associate” 5th edition, 2005

1. A method performed by a first network node, the method being for handling a set of nodes providing a segmented front-haul, the first network node operating in a communications network comprising the set of nodes, the method comprising:
determining, out of a respective first subset of nodes in the set of nodes to serve a respective device of one or more devices, a respective second subset of nodes to serve each respective device of the one or more devices, the determining based on information obtained from a second network node operating in the communications network, the information comprises respective routing information between a respective source node of respective one or more packets for the respective device of the one or more devices and the respective device, so that a respective delivery of the respective one or more packets to the respective device of the one or more devices is based on an improvement of one or more metrics; and
initiating sending of the respective one or more packets to the respective device of the one or more devices via the determined respective second subset of nodes.

2. The method according to claim 1, wherein the improvement of the one or more metrics is one or more of:
a transmission delay is reduced by using the second subset of nodes instead of using the first subset of nodes;
a transmission diversity or transmission reliability is improved by using the second subset of nodes instead of using the first subset of nodes;
a single user throughput is improved by using the second subset of nodes instead of using the first subset of nodes;
a system throughput is improved by using the second subset of nodes instead of using the first subset of nodes;
a lower amount of inter-user interference is generated by using the second subset of nodes instead of using the first subset of nodes; and
a lower amount of inter-user interference is generated by using the second subset of nodes instead of using the first subset of nodes.

3. The method according to claim 1, wherein the determining of the respective second subset of nodes comprises adjusting the respective delivery of the respective one or more packets to the respective device of the one or more devices based on at least one of:
one or more respective constraints in a communication interface between the respective source node and the respective device;
a communication capacity constraint of the segmented front-haul; and
nodes having experienced connection failure for the respective device.

4. The method according to claim 3, wherein the determining of the respective second subset of nodes comprises determining a plurality of respective second subsets of nodes for at least one of the one or more devices and wherein each respective second subset of nodes in the plurality is adjusted based on a respective constraint.

5. The method according to claim 1, further comprising at least one of:
obtaining first information indicating:
the one or more devices;
a respective characteristic of the nodes in the set of nodes; and
interconnectivity among the set of nodes; and
determining, based on the obtained first information, the respective first subset of nodes;
sending a first indication to the second network node the first indication indicating the determined respective first subset of nodes; and
receiving, responsive to the sent first indication, a second indication from the second network node, the second indication indicating the information indicating respective routing information, the information being based on the determined respective first subset of nodes.

6. The method according to claim 1, further comprising at least one of:
initiating sending of additional respective one or more packets from the respective device of the one or more devices to the respective source node via the determined respective second subset of nodes.

7. The method according to claim 1, wherein at least one of:
at least two of the one or more devices are co-scheduled,
the initiating of the sending comprises at least one of:
determining precoding weights for at least one of the nodes in the determined second subset of nodes; and
transmitting the respective one or more packets using the determined precoding weights;
each of the nodes in the set of nodes is an Access Point, AP;
the communications network is a distributed Multiple Input Multiple Output, d-MIMO, network;
the respective source node is a central processing unit, CPU, of the d-MIMO network;
the one or more respective constraints comprise at least one of: latency, segment capacity, spatial diversity and maximum path length;
a composition of the respective second subset of nodes is different than the respective first subset of nodes; and
one of:
a size of the respective second subset of nodes is smaller than the respective first subset of nodes; and
the size of the respective second subset of nodes is greater than the respective first subset of nodes by adding additional nodes not present in the respective first subset of nodes.

8. A method performed by a second network node, the method being for handling a set of nodes providing a segmented front-haul, the second network node operating in a communications network comprising the set of nodes, the method comprising:
receiving a first indication from a first network node operating in the communications network, the first indication indicating a determined respective first subset of nodes in the set of nodes to serve a respective device of one or more devices;
determining, responsive to receiving the first indication, for the respective first subset of nodes, information comprising respective routing information between a respective source node of respective one or more packets for the respective device of the one or more devices and the respective device, the information being based on the determined respective first subset of nodes, the information enabling the first network node to determine, out of the respective first subset of nodes a respective second subset of nodes to serve each respective device of the one or more devices, so that a respective delivery of the respective one or more packets to the respective device of the one or more devices is based on an improvement of one or more metrics; and
sending a second indication to the first network node, the second indication indicating the determined information.

9. The method according to claim 8, wherein the improvement of the one or more metrics is one or more of:
a transmission delay is reduced;
a transmission diversity or transmission reliability is improved;
a single user throughput is improved;
a system throughput is improved;
a lower amount of inter-user interference is generated; and
a lower amount of inter-user interference is generated.

10. The method according to claim 8, wherein the determining of the respective second subset of nodes is enabled to adjust the respective delivery of the respective one or more packets to the respective device of the one or more devices based on at least one of:
one or more respective constraints in a communication interface between the respective source node and the respective device;
a communication capacity constraint of the segmented front-haul; and
nodes having experienced connection failure for the respective device.

11. The method according to claim 9, wherein the determining of the respective second subset of nodes is enabled to improve the one or more metrics in the plurality of respective second subsets of nodes for at least one of the one or more devices, and wherein each respective second subsets of nodes in the plurality is enabled to be adjusted based on a respective constraint.

12. The method according to claim 8, further comprising:
performing route discovery in the respective first subset of nodes, to determine respective routing paths for the respective delivery of the respective one or more packets to the respective device of the one or more devices from the respective source node, and wherein the information is determined based on the performed route discovery.

13. The method according to claim 8, wherein at least one of:
at least two of the one or more devices are co-scheduled;
each of the nodes in the set of nodes is an Access Point, AP;
the communications network is a distributed Multiple Input Multiple Output, d-MIMO, network;
the respective source node is a central processing unit, CPU, of the d-MIMO network;
the one or more respective constraints comprise at least one of: latency, segment capacity, spatial diversity and maximum path length;
the information comprises at least one of: for each respective device of the one or more devices;
a respective aggregating AP receiving the respective one or more packets for the respective device from the respective source node and distributing them further to additional serving APs;
respective nodes in the set of nodes having experienced a successful connection or failure;
respective one or more routing paths;
respective reasons for connection failure of a node;
respective alternative routes explored; and
one or more of respective segment utilization, congestion, failure, and availability;
a composition of the respective second subset of nodes is different than the respective first subset of nodes; and
one of:
a size of the respective second subset of nodes is smaller than the respective first subset of nodes; and
the size of the respective second subset of nodes is greater than the respective first subset of nodes by adding additional nodes not present in the respective first subset of nodes.

14. A first network node, for handling a set of nodes configured to provide a segmented front-haul, the first network node being configured to operate in a communications network configured to comprise the set of nodes, the first network node being further configured to:
determine, out of a respective first subset of nodes in the set of nodes to serve a respective device of one or more devices, a respective second subset of nodes to serve each respective device of the one or more devices, the determining being configured to be based on information configured to be obtained from a second network node configured to operate in the communications network, the information being configured to comprise respective routing information between a respective source node of respective one or more packets for the respective device of the one or more devices and the respective device, so that a respective delivery of the respective one or more packets to the respective device of the one or more devices is configured to be based on an improvement of one or more metrics; and
initiate sending of the respective one or more packets to the respective device of the one or more devices via the respective second subset of nodes configured to be determined.

15. (canceled)

16. The first network node according to claim 14, wherein the determining of the respective second subset of nodes is configured to comprise adjusting the respective delivery of the respective one or more packets to the respective device of the one or more devices based on at least one of:
one or more respective constraints in a communication interface between the respective source node and the respective device;
a communication capacity constraint of the segmented front-haul; and
nodes having experienced connection failure for the respective device.

17. The first network node according to claim 16, wherein the determining of the respective second subset of nodes is configured to comprise determining a plurality of respective second subsets of nodes for at least one of the one or more devices and wherein each respective second subset of nodes in the plurality is configured to be adjusted based on a respective constraint.

18. The first network node according to claim 14, being further configured to at least one of:
obtain first information configured to indicate:
the one or more devices;
a respective characteristic of the nodes in the set of nodes; and
interconnectivity among the set of nodes; and
determine, based on the first information configured to be obtained, the respective first subset of nodes;
send a first indication to the second network node the first indication being configured to indicate the respective first subset of nodes configured to be determined; and
receive, responsive to the sent first indication, a second indication from the second network node, the second indication being configured to indicate the information configured to indicate respective routing information, the information being configured to be based on the respective first subset of nodes configured to be determined.

19. (canceled)

20. (canceled)

21. A second network node, for handling a set of nodes configured to provide a segmented front-haul, the second network node being configured to operate in a communications network configured to comprise the set of nodes, the second network node being further configured to:
receive a first indication from a first network node configured to operate in the communications network, the first indication being configured to indicate a determined respective first subset of nodes in the set of nodes to serve a respective device of one or more devices;
determine, responsive to receiving the first indication, for the respective first subset of nodes, information configured to comprise respective routing information between a respective source node of respective one or more packets for the respective device of the one or more devices and the respective device, the information being configured to be based on the respective first subset of nodes configured to be determined, and the information being configured to enable the first network node to determine, out of the respective first subset of nodes, a respective second subset of nodes to serve each respective device of the one or more devices, so that a respective delivery of the respective one or more packets to the respective device of the one or more devices is configured to be based on an improvement of one or more metrics; and
send a second indication to the first network node, the second indication being configured to indicate the information configured to be determined.

22. The second network node according to claim 21, wherein the improvement of the one or more metrics is configured to be one or more of:
a transmission delay is configured to be reduced;
a transmission diversity or transmission reliability is configured to be improved;
a single user throughput is configured to be improved;
a system throughput is configured to be improved;
a lower amount of inter-user interference is configured to be generated; and
a lower amount of inter-user interference is configured to be generated.

23. (canceled)

24. (canceled)

25. The second network node according to claim 21, being further configured to:
perform route discovery in the respective first subset of nodes, to determine respective routing paths for the respective delivery of the respective one or more packets to the respective device of the one or more devices from the respective source node, and wherein the information is configured to be determined based on the route discovery configured to be performed.

26. (canceled)
